(19) United States
(12) Patent Application Publication
(10) Pub. No.: US 2026/0079984 A1
(43) Pub. Date: Mar. 19, 2026

(54) SYSTEMS AND METHODS FOR SIMULATED MENTORING EXPERIENCE

(71) Applicant: Momentous Productions LLC, Plainview, NY (US)

(72) Inventor: Jared Shaw, Plainview, NY (US)

(21) Appl. No.: 19/327,718

(22) Filed: Sep. 12, 2025

Related U.S. Application Data
(60) Provisional application No. 63/694,490, filed on Sep. 13, 2024.

(51) Int. Cl. G06F 16/334; G06N 5/022; G06T 13/40

(52) U.S. Cl. CPC G06F 16/3347; G06N 5/022; G06T 13/40

(57) ABSTRACT

A computer-implemented method for providing a virtual mentor. The method includes training a mentor model based on input data and a selected training process to generate a trained mentor model. The input data includes information related to a real-life mentor. The method includes receiving one or more video inputs from a user computer, where the video inputs include a user performance. The method includes accessing a mentor specific curriculum for lesson progression; querying a knowledge database; and analyzing, using the trained mentor model, the user performance to detect one or more performance features. The method includes generating, using the trained mentor model, at least one response based on the one or more performance features, integrating media and interactive content, and generating a virtual mentor avatar configured to provide at least one feedback response to the user computer for display by the user computer.

### CROSS-REFERENCE TO RELATED APPLICATIONS

This application claims priority to U.S. Provisional Application No. 63/694,490, filed Sep. 13, 2024, the disclosure of which is incorporated herein by reference in its entirety.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Individualized mentorship and/or lessons can be expensive and limited based on geography, availability, etc. For example, the best music teachers or baseball coaches may be in high demand, may not live nearby, and may be too expensive for many people who would like to learn from them. Some mentors provide video/audio recordings of musical lessons, masterclasses, educational topics, or other types of coaching. While relatively inexpensive and accessible, these types of pre-recorded lessons are not interactive or specific to any particular user. Additionally, while some AI-based, interactive lessons exist, they often lack a structured framework that keeps sessions on track and may result in generic and inauthentic guidance.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a computer-implemented method for providing structured virtual mentoring. The method may include training, by a mentor knowledge base module, a mentor model using mentor-specific training data associated with a mentor. The method may include generating, by the mentor knowledge base module, a mentor-specific knowledge database based on the mentor-specific training data. The method may include providing, by a curriculum management module, a mentor-specific curriculum, and receiving, via a user interface of a user computing device, a performance input including at least one of audio data and video data for a user performance. The method may include analyzing, by a performance analysis module, the performance input to detect one or more performance features, and performing, by a knowledge base retrieval module, a query of the mentor-specific database to retrieve mentor-specific content based on the one or more performance features and the mentor-specific curriculum. The method may include determining, by the mentor model, a content type for a response based on at least one of the retrieved mentor-specific content, the mentor-specific curriculum, or the one or more performance features. The method may include generating, by the mentor model, a response based on at least one of the retrieved mentor-specific content, the mentor-specific curriculum, or the one or more performance features. The method may include rendering, by the mentor model, the response in the determined content type via the user interface.

In another embodiment, the disclosure describes a computer-implemented method. The method may include generating, at a core system, a mentor-specific curriculum based on mentor-specific training data for a mentor, and receiving, at the core system from a user computing device, a performance input including at least one of audio data and video data for a user performance. The method may include analyzing, by the core system, the performance input. The analysis may include implementing a performance analysis module to identify one or more performance features and implementing a curriculum management module to compare the one or more performance features of the mentor-specific curriculum. The method may include determining, by the core system, a content type for a feedback response based on the mentor-specific curriculum and the one or more performance features. The method may include generating, by the core system, a feedback response in the determined content type based on the comparison between the one or more performance features and the mentor-specific curriculum. The method may include synchronizing, by the core system, the feedback response with time-codes associated with the one or more performance features, and rendering, by the core system on the user computing device, the feedback response in the determined content type via the user interface.

In another embodiment, the disclosure describes a non-transitory computer-readable storage medium containing instructions for a method for providing a virtual mentor. The method may include training, by a computer, a mentor model based on input data to generate a trained mentor model, where the input data includes information related to a mentor. The method may include receiving, by the computer, one or more video inputs from a user computer, the video inputs including a user performance. The method may include analyzing, by the computer using the trained mentor model, the user performance to detect one or more performance features. The method may include generating, by the computer using the trained mentor model, at least one feedback response based on the one or more performance features, and generating, by the computer, a virtual mentor avatar configured to provide the at least one feedback response to the user computer for display by the user computer.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of one or more embodiments of the present invention when read in conjunction with the accompanying drawings. The components in the figures are not necessarily to scale, emphasis instead being placed upon illustrating the principles of the invention. In the figures, like reference numerals designate corresponding parts throughout the different views, wherein:

FIG. 1 is a symbolic diagram of an embodiment of an environment for a system for virtual mentoring as shown and described herein;

FIG. 2 is a schematic illustration of elements of an embodiment of an example computing device;

FIG. 3 is a schematic illustration of elements of an embodiment of a server type computing device;

FIG. 4 is a symbolic diagram of an embodiment of a modular architecture for operating the system for virtual mentoring as shown and described herein;

FIG. 5 is a flowchart of an embodiment of a method of using a performance analysis module of the system for virtual mentoring;

FIG. 6 is a flowchart of an embodiment of a method of interactive media integration for use in the system for virtual mentoring;

FIG. 7A is a flowchart of an embodiment of a Mentor Knowledge Base Module for virtual mentor training for use in the system for virtual mentoring;

FIG. 7B is a flowchart of an embodiment of a Knowledge Base Retrieval Module that may be a sub-process of the flowchart of FIG. 7A;

FIG. 8 is a flowchart of an embodiment of a system architecture for operating the system for virtual mentoring;

FIG. 9 is an example screenshot of an embodiment of a user interface of the system for virtual mentoring;

FIGS. 10A and 10B are example renderings of interactive tools for an embodiment of a user interface of the system for virtual mentoring;

FIG. 11A is an example depiction of a transition from a virtual avatar to pre-recorded media in an embodiment of a user interface of the system for virtual mentoring;

FIG. 11B is an example embodiment of the process for capturing a real life mentor for the purposes of creating the virtual avatar and/or hybrid media content.

FIG. 12 is an example screenshot of an embodiment of a user interface of the system for virtual mentoring; and

FIG. 13 is an embodiment of an admin console used for generating a curriculum lesson structure for the system for virtual mentoring.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

While AI-based instructional tools may broaden access, existing solutions are generally generic and do not reflect the distinctive pedagogy, personality, and consent boundaries of a particular real-life mentor. Interactive agents resembling a mentor or educator may respond unpredictably and fail to follow a deterministic sequence, leading to unreliable lesson progression. In addition, prior LLM systems may lack a structured curriculum or a dependable linkage between lesson state and a mentor-scoped knowledge base, and practical context limits may restrict surfacing relevant mentor-specific materials when needed. Avatar-centered experiences may be limited to generated avatars without incorporating pre-recorded mentor media or interactive tools, or, where both are used, the interweaving may be perceptibly disjointed. Further, existing systems may provide generic feedback, and may not offer real-time guidance at appropriate moments or authentic forms of feedback aligned with the real mentor's standards. Accordingly, there remains a need for systems and methods that provide authentic mentorship at scale with deterministic lesson orchestration, immersive hybrid media integration, enforceable mentor controls, real-time feedback, and efficient access to mentor-specific knowledge, as further described in the Summary below. Further aspects of the invention will become apparent as the following description proceeds and the features of novelty, which characterize this invention, are pointed out with particularity in the claims annexed to and forming a part of this specification.

As used herein, ‘avatar’ may mean a computer-generated or rendered character used to interact with users, whether photorealistic, stylized, fictional, composite, or based on a real individual.

As used herein, the terms ‘render,’ ‘generate,’ and ‘synthesize’ may encompass precomputed, procedurally produced, and on-demand real-time creation or updating of visual, audio, and scene content for the avatar and/or its surroundings, which may include via generative or neural-rendering methods as well as conventional graphics pipelines. ‘Real-time’ denotes latencies sufficient for in-session interaction on device, edge, or cloud over any transport (e.g., WebRTC, WebSocket, RTMP) and is not limited by a particular frame rate, codec, or hardware. The term ‘environment’ refers to any 2D, 2.5D, or 3D context in which instruction is presented, including flat interfaces, spatial scenes, VR/AR/MR, and volumetric or holographic displays, which may be static, dynamically assembled, or generated/updated in real time in response to curriculum state, user inputs, and/or performance metrics.

As used herein, the term “real-life mentor” may refer to a particular individual whose instructional content, style, or curriculum is used in whole or in part as training data. In some embodiments, the term may encompass a composite or aggregation of multiple individuals, a fictional or synthesized persona, or an instructional construct derived from existing curricula or other sources. As further used herein, a “mentor model” may denote a computational representation trained or otherwise configured to embody such instructional style, curriculum logic, or feedback characteristics. Accordingly, while certain embodiments may employ training data directly associated with a real individual to provide authenticity, other embodiments may employ mentor models not limited to any one person or entity. As further used herein, “mentor” or “mentoring” encompasses any instructional or guidance role, including a teacher, trainer, coach, facilitator, fictional character, onboarding guide, or enterprise compliance instructor.

As used herein, “curriculum” broadly refers to a structured sequence used to guide an interactive session; non-limiting examples include mentorship sessions, educational style courses, training sessions, enterprise onboarding and compliance, customer-support and sales role-plays, creative-direction reviews, skills practice, performance rehearsal/coaching, and product/equipment training, with curriculum retrieval, branching, and rendering governed by the deterministic lesson orchestration (e.g., tags, state, tool gating) described herein.

The disclosure describes, in some embodiments, a system for virtual mentoring that may include substantially real-time, interactive user performance evaluation that uses a combination of artificial intelligence (AI) and/or bespoke analysis models to analyze user performances and provide real-time feedback. In some embodiments, the system may leverage advanced analysis models to analyze audio inputs for various performance metrics, such as speech, pitch, tempo, rhythm, etc. In some embodiments, the system may also detect and analyze visual inputs, such as user movements (e.g., tennis stroke or drumming technique), posture, facial expression, and other visual indicators. The system may then generate detailed feedback based on the performance metrics, and synchronize the speech with a visual avatar. In some embodiments, the system may integrate text or native speech generation, text-to-speech conversion, and video synthesis with vision capabilities to provide interactive lessons via avatars. The result may be an individualized, realistic lesson by a virtual mentor.

In some embodiments, the disclosed system may provide an immersive, interactive experience that may go beyond traditional mentorship, offering users the opportunity to engage with master-level mentors across various fields, whether as a hobby, skill enhancement, or full vocational pursuit. This system may complement conventional teaching methods, and may deliver a dynamic and engaging experience akin to studying under a masterclass setting with expert mentors. The system may also support users seeking to learn from the best in their field, providing access to tailored guidance, interactive feedback, and personal insights from renowned mentors, enhancing the overall educational journey.

In some embodiments, the avatar may be based on real-life mentors such as musicians, actors, writers, chefs, entrepreneurs, teachers, coaches, etc., depending on the type of performance being evaluated. The system may include mentor models trained on prior recordings or other data related to the real-life mentor on whom the avatar is based. For example, in an embodiment including music lessons, the avatar may be based on a well-known drummer, drum teacher, guitarist, guitar teacher, piano teacher, etc. In some embodiments, the mentor model may be trained on the real person's teaching methods in teaching music lessons and real facts about the mentor's experience and history. Accordingly, the virtual mentor may react and teach in a manner similar to that of the real-life mentor, but tailored for an individualized approach for any user.

In some embodiments, the system may include a combination of prerecorded/pre-rendered mentor media (such as videos) intermixed with more specialized digitally-generated avatars of the mentor. The prerecorded media and virtually generated streaming video may be seamlessly integrated with one another. In some embodiments, the system may select, from a curriculum database, which prerecorded media to play that may be best-suited for a user's skill level and needs at any particular point during a lesson. Additionally, in some embodiments, the system may observe the user via a camera or other visual input device (e.g., laptop, tablet, phone, or other camera) to identify the user's movements, such as musical playing form, athletic movements, posture, gestures, etc. The system may then react to the user's physical movements and provide substantially real-time feedback via the virtually generated mentor. For example, the system may observe a user's posture (or other environmental factors) while playing drums, determine that a correction should be made based on training data, and provide feedback (via the virtual mentor) to correct the posture in a particular way.

In some embodiments, the disclosure describes several possible embodiments of the system, which may operate individually or in combination with one another:

### Comprehensive Training of Virtual Mentors:

In some embodiments, the system may provide a comprehensive framework for training, testing, and deploying virtual mentors that couples mentor capture with authenticity and compliance controls. Mentor-specific source materials may be acquired and curated under an end-to-end consent-tracking pipeline and aligned with the system's curriculum management and knowledge-retrieval components. This integrated approach may help reduce hallucination and unauthorized likeness use and may enable mentor-authentic guidance across the system.

Virtual mentors may be trained and/or fine-tuned using extensive data from recorded lessons, method books, prior works, etc., to replicate the mentors' expertise, technical skills, and teaching styles. In some embodiments, these mentor-specific reference materials may be used for training and/or fine-tuning the mentor models or may also be referenced in the mentor curriculum as reference material. In some embodiments, real life mentors may actively participate in diverse, real-world sessions to generate a wide range of exclusive content. These may include lesson recordings, adaptive knowledge acquisition Q&A sessions (which may be specially prepared for obtaining relevant information such as gaps in the mentor model's knowledge), technique demonstrations, performance critiques, digital shorts on their day-to-day, workshops, etc. These sessions may be recorded and segmented into various forms of media, which may then be integrated into the system's mentor model's knowledge base. This may help provide an expansive library of authentic, mentor-specific content that the system may draw upon to provide users with fresh, relevant, and personalized instruction. In some embodiments, virtual mentor avatars may also replicate distinctive teaching methods and personal anecdotes by referencing stored examples of authentic feedback and insights from the real-life mentor, which may help create an experience that is authentic and engaging. In some embodiments, training materials and feedback datasets may be embedded in the training process and stored in vector-based index, ensuring they are semantically structured and searchable. The system may use a vector query to determine the most relevant training material for each mentor in real-time. In some embodiments, this may allow for an “infinite” amount of material beyond any token limits or server constraints. In the user sessions, when needed, components of the system (e.g., the CMM 104 via the KBR 105, described below) may perform a vector query against the stored training materials to extract the most relevant content.

### Real-Time Performance Evaluation:

The system may analyze a user performance (e.g., musical performance, athletic performance, speaking performance, etc.) in substantially real-time, evaluating various performance metrics providing immediate feedback. For example, for music lessons, some metrics may include pitch, tempo, rhythm, etc. Such real-time feedback may help users understand strengths and areas for improvement, making each practice session productive. The mentor model may conduct this analysis directly or may rely on additional analysis models to independently conduct this analysis. Accordingly, the system may integrate analysis outputs in substantially real time, normalized to mentor-defined standards, to drive lesson progression and synchronized guidance, thereby reducing feedback latency and maintaining curriculum alignment.

### Multi-Modal Feedback Delivery:

The system may include pre-recorded media of mentors, and may also integrate native speech generation, text generation, text-to-speech, and video synthesis technologies to create a cohesive and interactive user experience, delivering feedback through a visual avatar that may be based on a real-life mentor. In some embodiments, the system may use an adaptive content selection process to selectively determine when to play pre-recorded media, such as based on a given teaching curriculum, a user's progress, or on particular inputs from the user (e.g., performances, instructions, verbal queues, etc.).

### Interactive and Personalized Learning:

The system's mentor model may be trained with hours of recorded lessons or other media of the real-life mentor to understand and replicate the personalized teaching methods of individual mentors, offering users a tailored learning experience. In some embodiments, users may benefit from structured curriculums while receiving individualized feedback and instruction tailored to their progress and needs, ensuring a balanced and effective mentoring experience. In some embodiments, the system may play back key moments of a user's performance with real-time comments from the digital mentor avatar, which may enhance a live lesson environment. In some embodiments, the digital mentor's comments or other feedback may be accompanied by visual annotations or other visual indicia that may be shown via a user interface. In such embodiments, users may critique their own performance within the context of the mentor's feedback, and may incorporate both auditory and visual feedback from the mentor. In some embodiments, after a mentoring session, the system may provide the user with a detailed report on performance, which may include metrics such as consistency and improvement areas. The system may also provide an automatic recap of key points and takeaways, along with the individualized assignments for future practice.

In some embodiments, the system may combine these elements to provide a user experience where, for example, the user may perform in real-time in front of a camera or upload a recording, the system may analyze the performance, and a virtual mentor based on a real-life mentor may provide realistic, individualized feedback on the user performance, and/or provide instruction for improvement. In some embodiments, the system may receive both audio (e.g., the user's performance) and visual inputs (e.g., video of the performance). The system may then analyze these inputs simultaneously to provide comprehensive feedback. In some embodiments, the system may generate native speech audio or text-based feedback, which may then be converted into speech using, for example, TTS (text-to-speech) technology. The system may then synchronize the speech with a visual avatar, creating an immersive and interactive lesson experience.

In some embodiments, the system may be trained to evaluate specific criteria such as correct notes, tempo consistency, proper technique in an example music session. It may also evaluate other criteria, such as a writing sample (e.g., script for film or television), negotiation tactics in business, building a personal brand, cooking technique, etc. By fine-tuning the virtual mentor on datasets of positive and negative performances that may have also been analyzed by the real-life mentor, the system may learn to identify and correct common mistakes. Much like in a real-life lesson, the user may then learn from the feedback, provide additional performances, and provide additional feedback in an iterative manner. In some embodiments, the system may evaluate the performance incrementally during the performance so that it can begin analyzing and developing feedback before the performance is complete, thereby providing feedback relatively quickly once the performance ends.

In some embodiments, the system may include multimodal processing capabilities. For example, the system may simultaneously handle text, audio, and visual inputs and outputs. With such integration, the system may analyze a performance by processing audio/visual data in substantially real time. In some embodiments, the system may include a multi-format upload module that may allow the system to ingest documents, reports, audio files, video recordings, MIDI data, and other performance-related content. This may enable users to submit pre-recorded performances or practice sessions in various formats, complementing real-time interactions. In some embodiments, enhanced vision abilities enable the system to process visual inputs effectively. This may include recognizing hand movements, posture, and/or identifying incorrect techniques or movements during a performance. In some embodiments, the system may provide substantially real-time interaction with response times that may be comparable to human conversation speeds, which may help provide smooth and natural feedback during a live mentoring session.

In some embodiments, the system may include substantially instantaneous text and/or native speech generation. The system may be integrated with a specialized real-time large language model and may be highly efficient, delivering near-instantaneous response generation. The system's vision capabilities may enable it to analyze visual inputs in substantially real-time, making it a robust choice for interactive mentorship tools or other immersive experiences. In some embodiments, by leveraging such capabilities, the system's interactions may be quick and responsive, providing substantially immediate feedback to users.

In some embodiments, the system may include integration of real-time video components. Traditionally, integrating seamless video components, such as real-time avatars and interactive media, may introduce latency. However, in the disclosed system, the latency between the avatar speech generation module to the video avatar may be minimal.

In some embodiments, the system may include dual-process real-time analysis and interactive avatar communication. For example, during regular interaction, the system may employ selective frame processing, transmitting only the most relevant visual data necessary for avatar responsiveness. In some embodiments, this may include identifying a minimum number of visual frames to send that convey enough information to indicate that something is notable, unique, or different from prior events in the user stream or other video. The system may use an adaptive process to select and send only the most important frames that show significant user deviations or actions, like shifts in posture or expressions. This may optimize bandwidth usage and help provide seamless, low-latency communication between the user and the virtual mentor. The system provides performance analysis and feedback by activating a separate, specialized process. Such embodiments may use advanced processes for incremental analysis, breaking down the performance into manageable segments. By processing these segments in real-time or substantially real-time, the system may generate virtually instant, targeted feedback on technique, timing, accuracy, etc.

In some embodiments, the system may optimize response generation by implementing efficient video processing. The system may employ algorithms that may prioritize speed and relevance, and may focus on updating specific elements (e.g., key posture changes for the user) rather than full-frame rendering, which may significantly reduce computational load and for server cost effectiveness. Response generation may also be optimized by using incremental feedback preparation. For example, as a user's performance progresses, the system may continuously analyze incoming data, prepare feedback in real-time, and subsequently store the resulting metrics or other data. This helps provide comprehensive, personalized insights substantially immediately upon completion of a user performance, which may enhance the dynamism and interactivity of the learning experience.

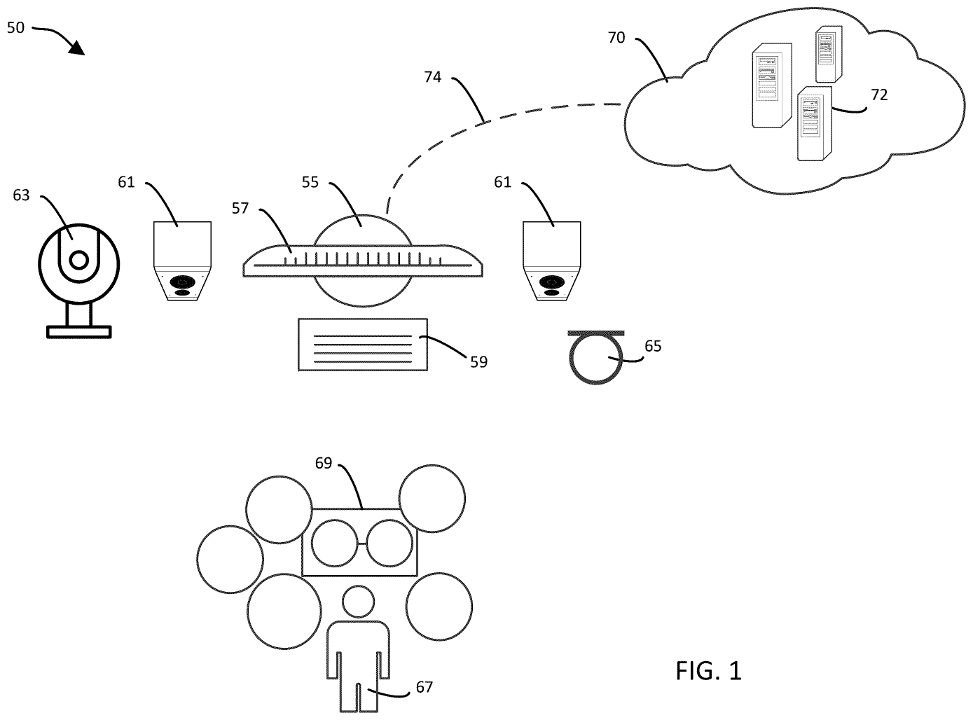

In some embodiments, the system may use a combination of the strategies described above to provide a near-real-time interactive educational or other immersive entertainment experience. Further, by leveraging the model's substantially instantaneous response generation and optimizing video component integration, the system may significantly reduce latency, helping to provide a smooth and engaging learning environment for users. FIG. 1 shows an embodiment of a simplified hardware environment 50 in which a user may operate and experience a system for virtual mentoring as described herein. The environment 50 may include one or more user computers 55 that may be of any suitable type, including desktop, laptop, tablet, mobile phone, virtual reality (VR) or augmented reality (AR) platform, implanted computer technology, etc. The computer 55 may include a monitor 57 for displaying visual output from the computer, and one or more input devices 59 (e.g., mouse, keyboard, etc.). The computer 55 may also be connected to one or more speakers 61 that may output audio from the computer, and which maybe built-in or external. The computer 55 may also be connected to one or more cameras 63 or other image sensors (e.g., motion, light, infrared, etc.) for capturing video and images and transmitting them to the computer. The camera 63 may be external or may be built into the monitor 57, computer, or other environment. The computer 55 may also be connected to one or more microphones 65 that may capture audio input and transmit the audio input to the computer, and may be built-in or external. It should be understood that the computer 55 and its various components may be connected via hardwire connections or wireless connections, such as Wi-Fi, Bluetooth, NFC, etc. Other computing environments may have more or fewer components and still be consistent with the disclosure. Although shown as separate components in FIG. 1, in some embodiments, the one or more user computers 55 and connected components 57-65 may be combined into a single computing device, such as a mobile phone, tablet, laptop, etc.

The environment 50 may also include a user, such a user 67 that may be using the user equipment 69. In some embodiments, the user equipment 69 may be a musical instrument (e.g., drum set, guitar, piano, etc.), sporting equipment (e.g., golf club, soccer ball, tennis racket, etc.), which may or may not be electronically connected to the computer 55 or its components. In some embodiments, the user 67 may have no user equipment at all, such as for embodiments involving mentoring related to speaking, singing, oration, leadership, etc. Additionally, in some embodiments, a user may use improvised equipment or other substitutes, and may still have a beneficial experience (e.g., a user practicing drums may use a practice pad instead of a full drum kit, but may still experience virtual mentoring through the adaptability and versatility of the system). In some embodiments, the camera 63 and the microphone 65 may be configured to capture images/video of and/or sound from the user 67 and/or the user equipment 69 in substantially real time and transmit those inputs to the computer 55 for processing or remote transmission.

In some embodiments, one or more components in the environment 50 may be connected (either through hard wires or wirelessly) to a remote computing environment 70. The remote computing environment 70 may include one or more remote servers 72 that may be connected in one or more networks. The remote servers 72 may be disposed in one physical location or may be distributed in various locations electronically connected to one another. In some embodiments, the computer 55 may connect to the remote computing environment 70 via a suitable communication network 74, such as the internet, cellular networks, local networks, etc. In some embodiments, the system for virtual mentoring may reside on one or more remote servers 72 in the remote computing environment, may reside on the user computer 55, or may reside in a combination of the user computer and the one or more remote servers. In some embodiments, certain processes of the system for virtual mentoring may occur locally on the computer 55, and certain other processes may occur on the one or more remote servers. Data relating to operating the system may be transmitted between the computer 55 and/or its components and the remote computing environment 70 via one or more streaming protocols or other suitable computer or network data transmission protocols.

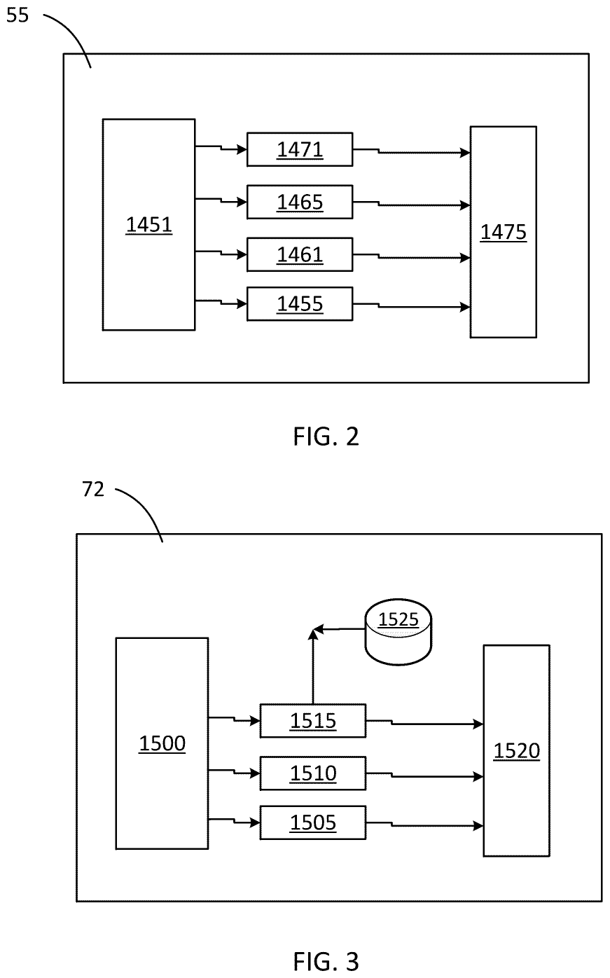

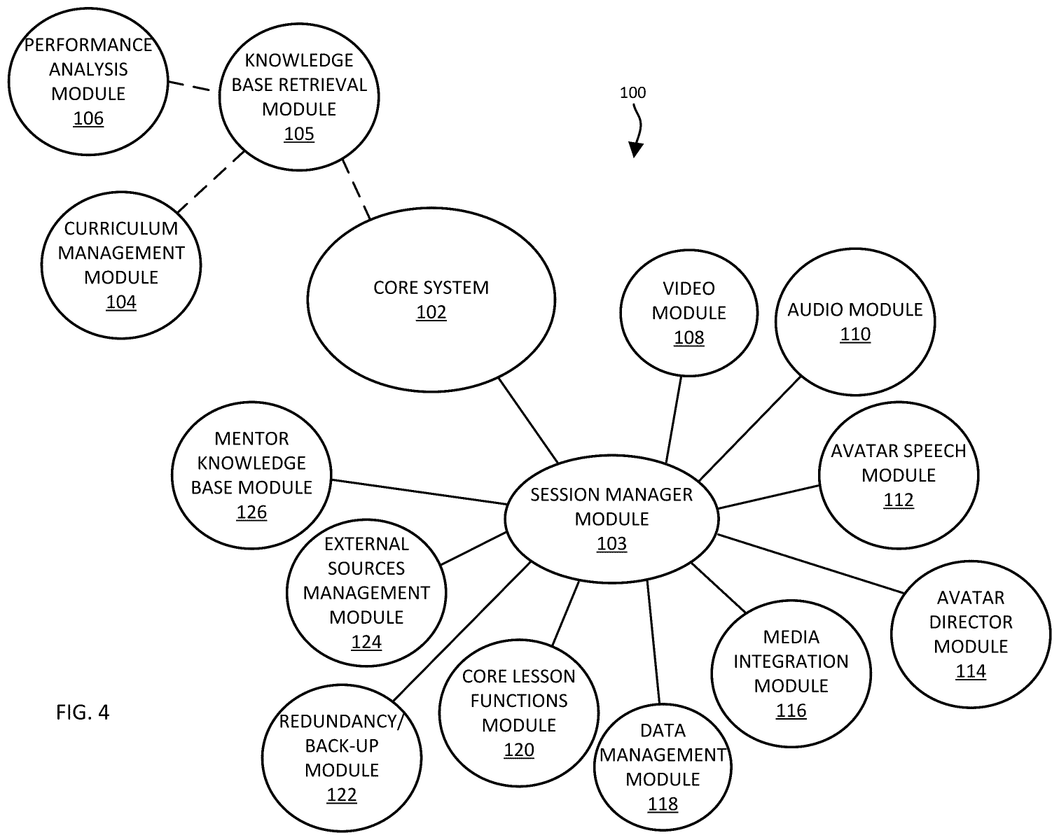

FIG. 2 is a simplified illustration of some physical elements that may make up an embodiment of a computing device, such as the computing device 55, and FIG. 3 is a simplified illustration of the physical elements that make up an embodiment of a server type computing device, such as may be used for the one more remote servers 72. Referring to FIG. 2, a sample computing device is illustrated that is physically configured to be part of the systems and method for virtual mentoring. The computing device 55 may have a processor 1451 that is physically configured according to computer executable instructions. In some embodiments, the processor may be specially designed or configured to optimize communication between a server relating to the system described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera, a display, or other input/output devices. The computing device 55 also may control communicating with networks either through wireless or wired devices. Of course, this is just one embodiment of a computing device 55 and the number and types of computing devices 55 is limited only by the imagination.

The physical elements that make up an embodiment of a server, remote server 72, are further illustrated in FIG. 3. In some embodiments, the server 72 may be specially configured to run the system and methods for virtual mentoring as disclosed herein. At a high level, the server 72 may include a digital storage such as a magnetic disk, an optical disk, flash storage, non-volatile storage, etc. Structured data may be stored in the digital storage a database. More specifically, the server 72 may have a processor 1500 that is physically configured according to computer executable instructions. In some embodiments, the processor 1500 can be specially designed or configured to optimize communication between a computing device, such as user computer 55, and A/V equipment or remote cloud server 72 as described herein. The server 72 may also have a sound and video module 1505 which assists in displaying video and sound and may turn off when not in use to conserve power and battery life. The server 72 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks either through wireless or wired devices. In some embodiments, a virtual mentor controller for running a virtual mentor API may be located on the computing device 55. However, in other embodiments, the virtual mentor controller may be located on server 100, or both the computing device 55 and the server 100. Of course, this is just one embodiment of the server 100 and additional types of servers are contemplated herein.

### Modular Architecture:

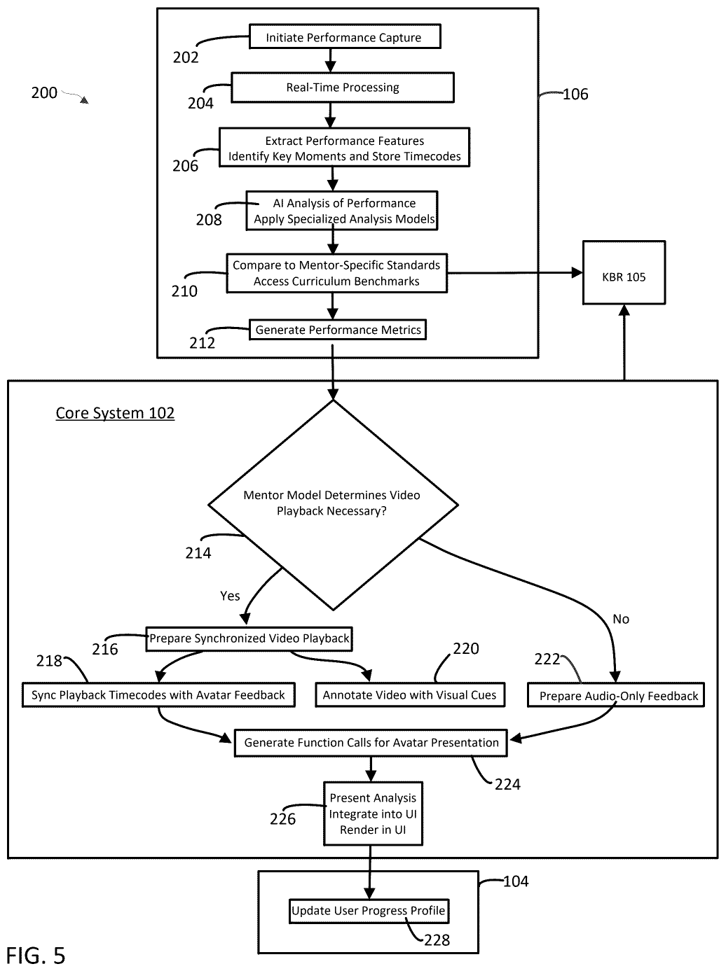

In some embodiments, the system may employ a modular lesson architecture in which the session manager may coordinate distinct modules which may pass context back to the core mentor model, such as a Curriculum Management Module (CMM 104), a Performance Analysis Module (PAM 106), a Knowledge Base Retrieval module (KBR 105), to deliver a structured yet adaptive mentoring experience. For example, the CMM 104 may express the lesson plan as a formal, deterministic script of lesson items with constraints and conditional tags, while the PAM 106 may supply time-coded performance analysis and the KBR 105 may surface mentor-scoped materials keyed to lesson state. This separation of concerns and context passed back to the mentor model may enable reliable sequencing, user personalization, authentic real-time feedback, and may scale across a variety of mentors and domains. Accordingly, in some embodiments, the disclosed design may provide determinism and proper context retrievals where needed and dynamic flexibility where useful, as further detailed with reference to FIG. 4.

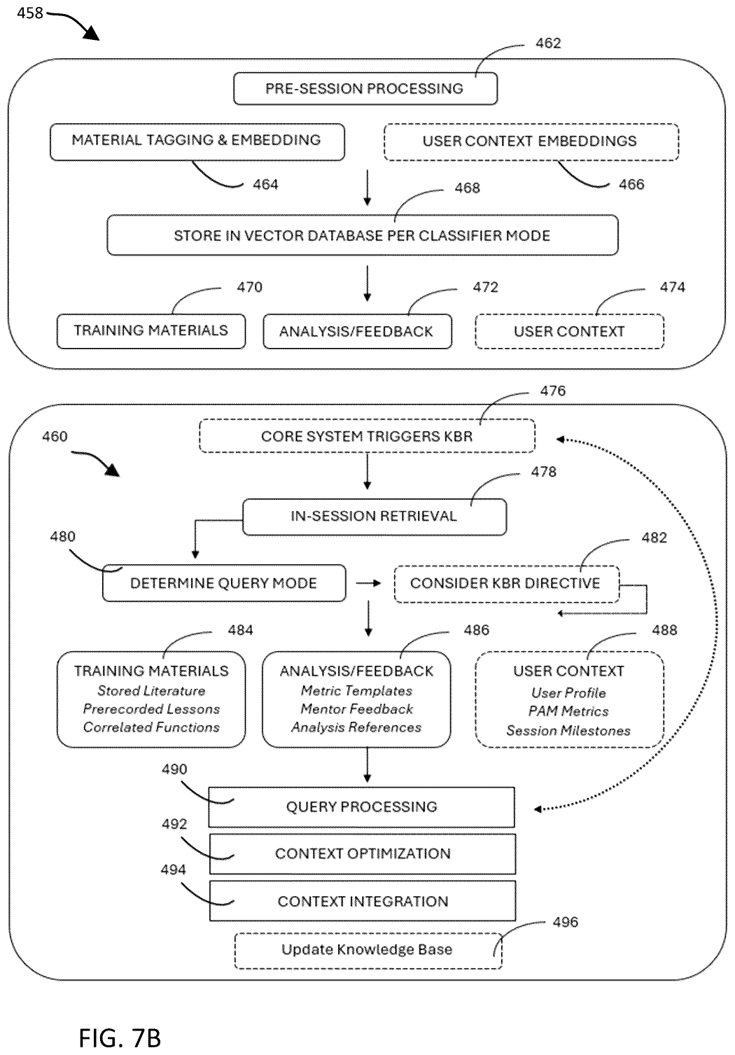

FIG. 4 is a diagram of the modular architecture for an embodiment of a system for virtual mentoring 100. The system 100 may include a mentor model that may include a core system 102 and a session manager module 103 with one or more modular systems that may interact with the core system individually or in combination for the core system to process inputs and provide outputs to the user computer 55 that support the virtual mentoring process. In some embodiments, the core system 102 may be powered by a custom real-time mentor large language model (LLM) with vision and native speech generation capabilities that may drive dynamic, natural conversations between the user (e.g., user 67) and the mentor's virtual avatar, reflecting the mentor's unique teaching style and expertise. In some embodiments, the real-time language model may support interruptible streaming inference with mid utterance cancellation, enabling response and tool invocation without session renegotiation while maintaining minimal end to end latency. In some embodiments, the core system 102 may support asynchronous function calls and interleaved text responses, allowing non-blocking tool invocations (e.g., media integration or performance analysis) to proceed in parallel with ongoing conversational output, thereby enabling interruptible, low-latency interactions while adhering to the lesson structure's constraints. The mentor model powering the core system 102 may be substantially influenced by the pre-session training processes conducted by the Mentor Knowledge Base 126 and stored in the Knowledge Base Retrieval Module 105, as detailed respectively further below in FIGS. 7A and 7B. The mentor model used by the core system 102 may be prompted with mentor-specific and system-wide prompts for the purposes of embodying the mentor. For example, mentor-specific prompts for the model might include training context specific to the mentor, such as the results of the mentor knowledge base module 126 and KBR 105, and system-wide prompts, such as what might be relayed by core lesson functions module 120, might be rulesets and specifications that apply to any mentor used by the system, ensuring the core system 102 output provides the expected results for delivering a functional, seamless, and reliable mentoring result. In some embodiments, the core system 102 and sub-modules (CMM 104, PAM 106, and KBR 105) may be configured on a mentor specific basis, while the session manager module 103 and its sub-modules may be a system-wide framework used by any mentor model. As used herein, unless stated otherwise, the term “mentor model” refers to the core system 102. In some embodiments, the core system 102 may draw upon one or more of the modules and/or submodules, such as the curriculum management module (CMM) 104, and may use curriculum defined tools and function calls to seamlessly integrate media elements, such as video demonstrations and interactive tools, into a conversation flow between the virtual mentor and the user, which may provide content that may be contextually relevant. In some embodiments, the core system 102 may interpret data, such as performance metrics and time-coded performance data, from one or more modules, such as a performance analysis module (PAM) 106, and may generate context-specific feedback (e.g., performance playback) that may be integrated into the ongoing dialogue. In some embodiments, the knowledge base retrieval (KBR) module 105 may be activated directly by the core system 102 and may also communicate with the CMM 104 and/or the PAM 106. In some embodiments, the core system 102 may control and enhance the immersion of the virtual mentoring experience by dynamically orchestrating interactions between the user and the virtual mentor. Further, by drawing from the different modules and sub-modules, the system may seamlessly integrate media elements, knowledge base retrievals, performance feedback, and conversational flow in a way that may be both optimized and contextually relevant.

In some embodiments, the system 100 may include a session manager module 103. The session manager module 103 may communicate with and manage one or more sub-modules, such as a video module 108, an audio module 110, and an avatar speech module 112, avatar director module 114, media integration module 116, data management module 118, core lesson functions module 120, redundancy and backup module 122, external sources management module 124, mentor knowledge base module 126, etc. In some embodiments, the session manager module 103 may serve as a core orchestration layer that may bring together various technologies (analysis models, content integration, avatar generation, knowledge retrieval, etc.) to create a cohesive, interactive experience. In other words, it may act as the “conductor” that ensures all parts of the system work together to deliver a seamless mentorship session.

In some embodiments, the system 100 may be built within a modular architecture such that each module may operate independently yet may integrate seamlessly into the core system 102. In some embodiments, such modularity may improve scalability by allowing the system to expand across different domains (e.g., music mentoring, sports, film, etc.). In some embodiments, each module may be designed to integrate with the core system 102. For example, the PAM 106 may function independently from other modules to capture and analyze performance data in real-time or substantially real time. Once analysis is complete, the PAM 106 may pass structured time-coded data and performance metrics to the core system 102, which may then interpret and analyze the structured time-coded data and integrate such feedback into the overall lesson flow to provide continuity and relevance.

In some embodiments, the avatar director module 114 may manage avatar animation and interaction states, camera/viewing angles, avatar positioning, settings, synced movements, etc. In some embodiments, the avatar director module 114 may control dynamic avatar state behaviors, including start/stop talking, interruptions from user, scripting step-by-step breakdowns of performance analysis, custom mentor animations, and switching between different camera shots and environments to enhance the immersive experience. In some embodiments, the media integration module 116 may facilitate a smooth inclusion of pre-recorded/pre-rendered and/or dynamically generated media content into the lesson flow. The media integration module 116 may also help provide contextual relevance and seamless transitions between different content types, maintaining a cohesive user experience. In some embodiments, data management module 118 may manage the flow and storage of data within the system, which may include performance metrics, user progress, feedback data, etc. The data management module 118 may also handle online connectivity and data synchronization across various modules to ensure real-time operation. In some embodiments, the core lessons functions module 120 may provide lesson management tools, including system-wide prompts, timers, milestones, and other tracking functions that may be used by any mentor model employed by the system. The core lessons functions module 120 may support lesson continuity and structure, which may enhance the overall learning or entertainment experience.

In some embodiments, the functions of the data management module 118 and the core lessons functions module 120 may be provided by the session manager module 103. As described above, the session manager module 103 may serve as a core orchestration layer that may bring together various technologies to create a cohesive, interactive experience. In some embodiments, the session manager module 103 may provide initialization and status tracking, may handle session initialization, connection, state tracking, and termination. In some embodiments, the session manager module may also assign the correct mentor, curriculum, and user context to the session, as well as track session duration. The session manager module 103 may also handle turn-detection management, such as by controlling the conversational flow between the user and the core system 102, such as via the virtual mentor. In some embodiments, this may be done with semantic voice activity detection. Accordingly, the session manager module 103 may act as an intermediary with the core system 102, such as via system messages.

In some embodiments, the session management module 103 may provide user context and input integration. This may include enhanced session context in which detailed user profiles may be integrated, and the results of pre-session questionnaires may be passed to the core system 102 for user context pre-session. Additionally, visual data about the users current setting, time constraints, and learning preferences may be passed. User context and input integration may also include user progress tracking and storage. This may include implementation of system progress tracking and strategy management, which my help ensure real-time updates on user performance and progress. In some embodiments, user progress in sessions may be consolidated by the core system 102 and stored as progress data. In some embodiments, the system may generate a consolidated key “performance report” which may be passed to the context of future sessions as well as user post-session. The progress data and key performance report may also be stored in the KBR 105 for real-time context retrieval on user's prior progress in future sessions.

In some embodiments, the session manager module 103 may provide system messaging updates, such as cross-module context sharing, carry-on messaging system, time synchronization and session management, performance data relay, and adaptive system feedback loops. Cross-module context sharing may include the system messaging system facilitating real-time data exchange between the modules. For example, the PAM 106 metrics that inform targeted practice tips may be passed via the session manager module 103 to the core system 102 to be relayed to the user. A carry-on messaging system may help ensure seamless session flow by relaying user actions (e.g., finishing a video demo or recording capture) as contextual system messages to the mentor (i.e., the core system 102). This may allow the session to progress naturally without explicit system references. Time synchronization & session management may provide structured time updates to align lesson pacing. System messages ensure all interactive elements and media to occur in a given curriculum (e.g., exercise demonstrations, practice assignments) are triggered at the appropriate time within the session lifecycle. Certain time updates might warrant more sever actions. For example, a time update with only 1 minute remaining, may alert the core system/102 to skip over the end of a lesson structure in order to wrap up the session in time. These time-based decisions are inferred by the lesson structure time constraints already tagged in lesson structure via the CMM 104.

Performance data relay may include capturing and transferring performance metrics (e.g., timing accuracy, posture results, stylistic integrity, etc.) across modules, which may help ensure consistent context. For example, after a recording a user session or performance, system messages may notify the mentor via the core system 102 to provide feedback based on the PAM 106-analyzed technique insights. An adaptive system feedback loop may include dynamic updates for adjusting lesson flow based on user engagement. For example, if a user struggles with a specific section, system messages may notify the mentor to reinforce guidance or adjust the difficulty dynamically within the CMM lesson structure.

The redundancy/back-up module 122 may help provide system reliability by incorporating redundancies and backup mechanisms. In some embodiments, the redundancy/back-up module 122 may maintain seamless operation during unexpected disruptions or data loss scenarios. In some embodiments, the external sources management module 124 may manage interactions with external data sources and services, such as external analysis models being used by the PAM via APIs. In some embodiments, this may enable the system to pull in, send out, or otherwise transmit relevant data, such as third-party content, or cloud-based storage. The external sources management module 124 may also facilitate seamless integration with external tools, services, and platforms (e.g., via APIs) that may enhance the functionality and reach of the virtual mentoring system, such as via the PAM 106. The external sources management module 124 may also handle authentication, data exchange, and may help provide secure, optimized connections between the core system 102 and external entities, thereby supporting the broader ecosystem of the virtual mentoring experience. Performance Analysis Module

To support precise, authentic feedback, the system may include a Performance Analysis Module (PAM 106). The PAM may evaluate input data during capture and produce performance metrics that may include structured, time-aligned analysis tied to the user's actions. In contrast to static analytics or free-form LLM commentary, analysis derived from the PAM may guide when and how feedback is delivered by the core system 102, enabling authentic guidance, synchronized annotated playback, and lesson-aware adjustments, as further described below.

In some embodiments, the PAM 106 may provide analysis for a user performance based on observed performance criteria. In some embodiments, the PAM 106 may operate on its own, in standalone operation. The PAM 106 may be activated, for example, independently during a performance capture (e.g., when a user is recording a performance in the environment 50, such as shown in FIG. 1). The PAM 106 may be trained on custom benchmarks specific to the domain (e.g., drum strokes, tennis swings, etc., analyzed by the mentor) and may perform video/audio/textual analysis, selectively storing time codes corresponding to key performance moments and tracking metrics like technique, timing, accuracy, etc., as they occur during the user performance. In some embodiments, the system may use Time-Coded Data Handling. For example, the performance data may be structured in a format (such as JSON), with each entry including time stamps, event types (e.g., ‘missed beat’, ‘incorrect posture’), and corresponding metrics. In some embodiments, the PAM 106 may transmit the performance data to the core system 102, and may also consult KBR 105 for contextual, analysis-based authentic feedback examples and/or training materials based on the provided analysis. After receiving the PAM 106 metrics, the core system 102 may interpret these metrics and may generate tailored feedback that may be aligned with specific moments in the performance. For example, the system may play back the 37-42 second mark in slow motion and say (e.g., via the virtual mentor), “At this point, your stroke lacked follow-through, which impacted your timing. Focus on extending your motion through the hit.”

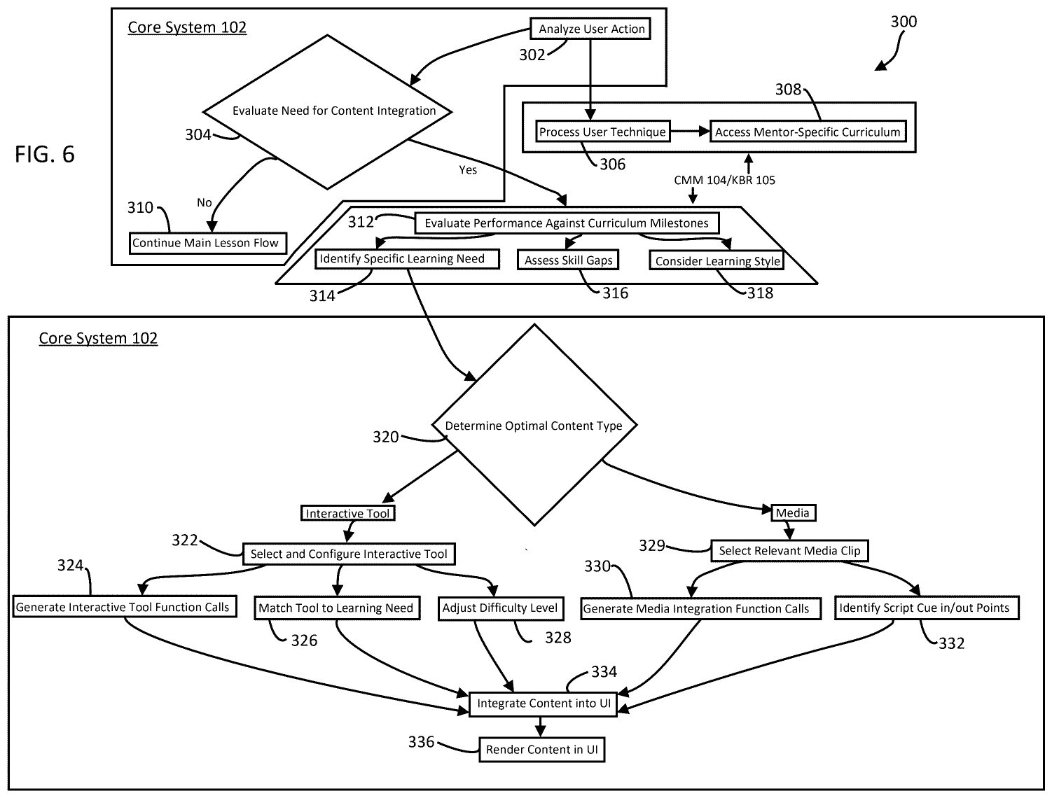

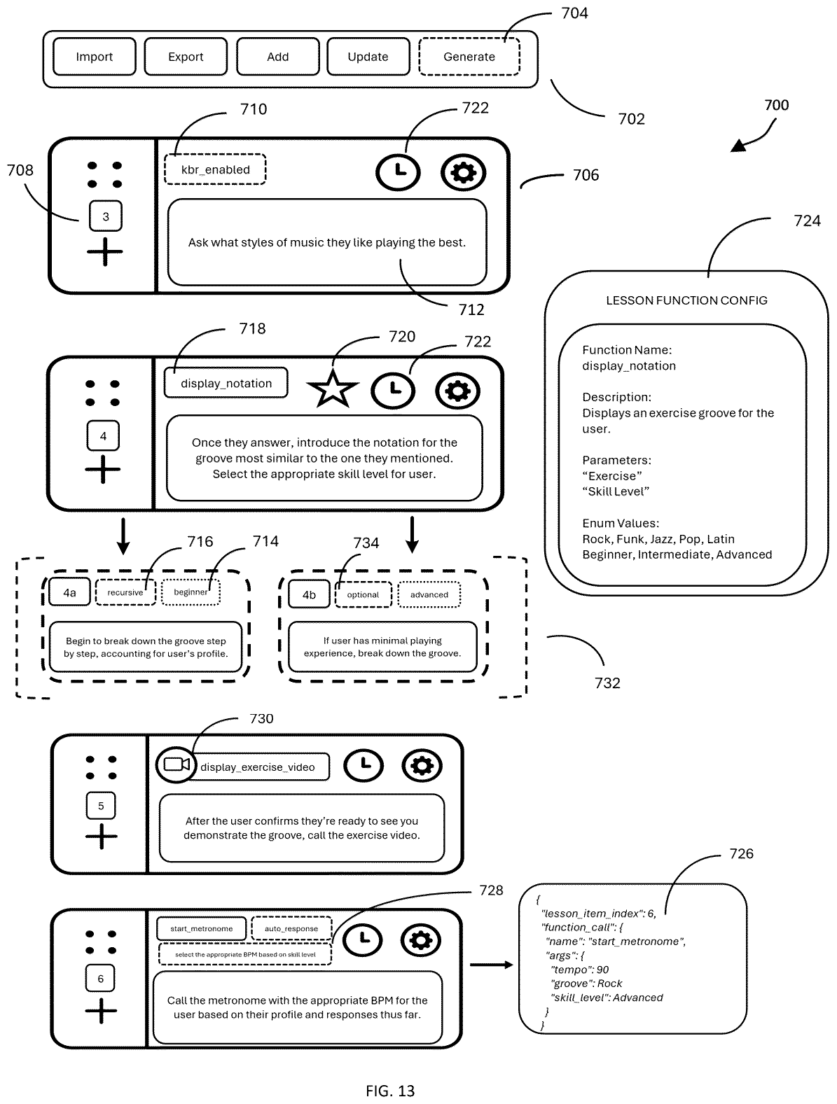

FIG. 5 includes a flowchart illustrating an embodiment of method 200 of using the PAM 106 along with a playback process performed by the core system 102. In some embodiments, the PAM 106 and core system may provide video time-coding feedback by integrating a video time-coding system that provides both visual and textual annotations during key performance moments of a user performance. In some embodiments, at 202, a performance capture of a user performance may be initiated by the PAM 106, either independently or via the core system 102. The initiation of a user performance might also be dictated at specified lesson items in the curriculum as determined by the CMM 104 (such as is described later in FIG. 13). At 204, the PAM 106 may perform real-time processing of performance data collected, such as via cameras 63, microphones 65, and/or other sensors in the environment 50. In some embodiments, the performance may include a user (such as user 67) and user equipment 69, but those skilled in the art will recognize that many different types of performance may occur. At 206, the PAM 106 may extract performance features, identify key moments of the performance, and store timecodes for those moments. The timecodes may be precisely analyzed and passed back for context-specific feedback. The analysis models used to determine the key moments may y be trained and prompted based on the real-life mentor standards/benchmarks for user comparison and analysis. For example, in an embodiment where the user 67 may be playing the drums, the PAM 106 may identify moments of the performance where rhythm may be off, or where the user's technique could use improvement based on these analysis models and benchmarks.

In some embodiments, time-coded moments may be predetermined based on specific performance benchmarks the system may use for analysis in a particular lesson/exercise. For example, in a particular practice exercise of a musical play-along track where the user may prompted or otherwise expected to perform a drum fill in sync with the playback, the system may predetermine that timecodes for beats 3 and 4 of measure 4, for example, may be relevant for such an analysis. Additionally, the system may autonomously detect key moments in real-time based on the user's performance and the type of content being captured, utilizing the continuous audio/video stream from the user. Even when the user may not be directly performing for the mentor, the system may intelligently monitor and adapt to the user's progress, for example, by using the video feed to assess and dynamically adjust feedback. At 208, the PAM 106 may perform analysis of the performance, and may apply one or more models, such as specialized machine learning (ML) models, specially trained and/or fine-tuned neural networks, etc., to accurately evaluate and interpret the user's actions At 210, the PAM 106 may consult analysis/feedback examples stored in KBR 105 to compare the performance analysis to standards that may be specific to the virtual mentor, or specific to the real mentor on which the virtual mentor may be based. In some embodiments, the PAM 106 may access curriculum benchmarks and compare those benchmarks to the performance analysis. At 212, the PAM 106 may generate performance metrics for the specific performance and transmit those metrics to the core system 102.

In some embodiments, these metrics may originate from the PAM 106 and may include relevant metrics tailored to the specific vocational area (e.g., tempo, rhythm, and accuracy for music; kinetic chain analysis for sports, etc.). The PAM 106 metrics may be formatted into a structured data set and transmitted as a system message to the core system 102. The core system 102 may then use the performance metrics to interpret the feedback and render the user's performance within the UI effectively. For example, the PAM 106 may transmit a JSON object that may contain timestamped metrics such as “tempo_deviation” or “movement_efficiency” to the core system 102, which may enable it to display corresponding feedback and performance highlights in real-time on the user interface.

Upon receiving metrics from the PAM 106, the core system 102 may also invoke the KBR 105 to retrieve mentor-scoped feedback materials. In some embodiments, as further described with reference to FIG. 7B, the KBR 105 may maintain metric-triggered analysis templates in an analysis reference namespace, where each template may specify trigger metrics (e.g., scoreAbove, scoreBelow) that define insertion conditions. For example, if the PAM 106 streams an overall score below a defined threshold (e.g., <70%), the KBR 105 may return only the templates matching that condition. The core system 102 may then render personalized guidance using the retrieved template and session context (e.g., indicating that a user's musical timing averaged 66% accuracy and recommending practice at 80 BPM).

In some embodiments, the PAM 106 may leverage a variety of analysis models that may run simultaneously to handle the tasks such as storing key moments in timecode, generating performance metrics, and providing real-time instant feedback. For example, in a mock-negotiation scenario, two analysis models may be running concurrently: an independent native video/audio processing model, and a purely text-based model receiving the user's speech response in real-time using text-to-speech. Both models may be trained on the mentor's benchmarks. Following the recording of the user's performance, the text-based model may process an immediate analysis of the user's “speech” to provide instant textual feedback while the video model may be processing the video's key moments and generating the timecodes and performance metrics in the background to be displayed shortly thereafter. In this example, following the scenario, the results from the text model may allow the core system 102 mentor model to immediately give tangible feedback on the user's performance and discuss with the user before the PAM 106 metrics and key moments are introduced by the avatar for more context. In some embodiments, the PAM 106 models may output in a JSON format passed to the core system 102 via system messages with the metrics, timecoded moments, and observations.

In some embodiments, during a user session, the PAM 106 may leverage technique feedback loops that may be capable of analyzing diverse user inputs (e.g., motion capture data from video, audio signals), classifying user actions into predefined mentor-attributed techniques via bespoke analysis models, and assigning a performance fidelity score. This process may help ensure real-time identification of the performed technique and accurate assessment against mentor-established benchmarks to these techniques. The PAM 106 may also provide expert-guided embeddings and personalized feedback. For example, the expert-demonstrated common mistakes may be embedded within a vector database, such as in the feedback/analysis queries stored in KBR 105, enabling nuanced corrective feedback tailored precisely to mentor styles when retrieved by the PAM 106. Multiple textual variations of observational feedback may be stored as reference to these techniques, ensuring varied, natural-sounding interactions during real-time interventions. The PAM 106 may also provide cross-domain adaptability and input generalization. In some embodiments, emphasis may be on the universal framework where input acquisition and preprocessing vary by domain, while the core principles of technique identification, performance scoring, and contextualized mentor feedback remain consistent and scalable.

At 214, based on the metrics, identified key moments, timecodes, and observations received from the PAM 106, the core system 102 may determine how the system should provide feedback, such as via video playback, audio (avatar speech-only) playback, etc. The core system 102 may parse the timecoded moments and metrics received from the PAM 106 to display the results, such as via the computer 55 or other interface, and the core system 102 may reference the metrics and observations from the PAM 106 and/or feedback queries from the KBR 105 to contextualize feedback in its natural language responses. In some embodiments, the core system 102 may conduct light analysis for general technique detection and feedback, and more advanced analysis may take place in dedicated performance captures when initiated by the core system 102 and analyzed by the PAM 106. The core system 102 may interpret performance metrics from the PAM 106 system message and may be trained in its prompting to intelligently determine when to include video playback in the respective function call. This decision-making may also follow a curriculum-based ruleset to determine appropriate playback scenarios based on tags at certain lesson index items dictated by the CMM 104, such as a tag specifying playback if the accuracy falls below 65%, ensuring feedback is constructive and contextually relevant. Examples of the curriculum lesson structure and tagging system this might be based on is further described in FIG. 13. At 216, if the core system 102 determines that video playback may be appropriate, the core system may prepare synchronized video playback. In some embodiments, the core system 102 may preload and cue the video to prepare for the subsequent syncing steps to help provide smooth playback integration. In some embodiments, the system may employ a dual analysis architecture that may simultaneously capture and process distinct media streams for rapid preliminary feedback, and may enable a responsive user experience while deeper analysis occurs.

At 218, preparing the video playback may include syncing playback timecodes with feedback provided by the virtual avatar. The core system 102 may implement a bidirectional timestamp mapping process that may correlate analysis annotations with video playback positions, enabling frame-accurate highlighting of key moments regardless of playback device characteristics. In some embodiments, the avatar feedback may be generated by the core system 102 and/or by referencing targeted analysis/feedback queries in KBR 105 based on the analysis conducted by the PAM 106 (e.g., in steps 202-212). The PAM 106 may capture performance metrics, which may also include time-specific moments to cover, which may then be interpreted by the core system 102. For example, if the core system 102 identifies specific performance elements, such as the timecodes of a specific tennis swing or a drum hit, these performance elements may be used to cue and sync playback at those precise moments, which may allow the system to deliver context-specific feedback that may align with the user's actions. For example, the timecodes may correspond to the stored key moments that may have been identified by the PAM 106. In some embodiments, the time-coding system may provide precise timestamp tracking and time-to-seconds conversion for accurate playback control. The system may highlight clip range management with context preservation, and may automatic loop control for key performance segments.

In some embodiments, the synchronization and breakdown of key timecoded performance moments with the avatar's feedback may, in part, be managed by the avatar director module 114. The avatar director module 114 may coordinate the avatar's actions, including starting and stopping avatar speech at the key moments, changing positions, or pausing to await user responses, in line with the timecoded feedback breakdown. For example, if the PAM 106 metrics and corresponding avatar response from the core system 102 indicate a critical moment at a specific timecode, the avatar may be programmed to pause and provide targeted advice, step-by-step, during the synced playback. This may help ensure that feedback is delivered in a natural and easily digestible format for the user. Additionally, such a structured approach may help make the feedback iterative and interactive, closely mirroring a real-life mentoring experience.

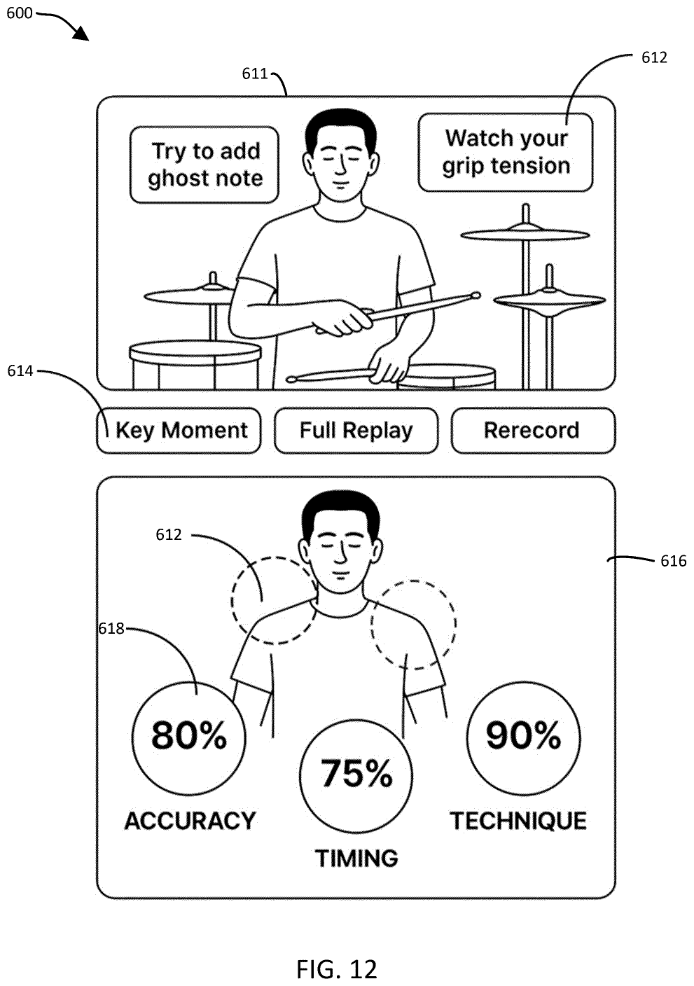

In some embodiments, at 220, the core system 102 may annotate the video playback with visual cues. The visual cues annotated by the core system 102 during video playback may include elements such as highlighted areas on the video to indicate specific errors or correct techniques, directional arrows to guide proper hand or foot movements, color-coded overlays representing timing deviations, or dynamic markers indicating optimal strike zones on instruments (e.g., drums or piano keys). In some embodiments, a real-time annotation UI display may be synchronized with video playback and position-based annotation rendering. FIG. 12, described in more detail below, provides an example of an annotated playback screen with performance metric results and timecoded playback that may be used in some embodiments. These cues may be generated based on the performance metrics and timecoded data provided by the PAM 106. The cues may include visual cue formatting instructions, and may be synchronized with the feedback presented by the virtual mentor avatar to help contextually align the visual guidance with the feedback, which may enhance the user's comprehension and engagement during the playback. Based on the playback timecodes and/or the PAM performance metrics analysis, the core system 102 may generate one or more function calls for a presentation by the virtual mentor avatar via the computer 55.

In some embodiments, if the core system/mentor model 102 at 214 determines that video playback may not be necessary, at 222, the system may prepare avatar audio/speech-only feedback that may be played on its own or over a video of the user performance, such as at the key moments identified by the performance analysis module 106. At 224, the core system 102 may generate function calls for the avatar audio/speech-only feedback presentation and/or the playback timecodes described at 218. At 226, the core system 102 may present the feedback analysis, such as by integrating the analysis into a user interface and/or rendering the analysis into the user interface. For example, the presentation may include presenting the avatar feedback on screen via the virtual mentor avatar, and may also allow the user to replay identified key moments at their discretion or rerecord. In some embodiments, the avatar's feedback presentation may also include video playback with visual cues (such as described above at 220), and may include shifting the avatar to a different position in the UI, such as smaller, in a corner, etc., to make room for the visual cues. In some embodiments, at 228 and as described in more detail below, the curriculum management module (CMM) 104 may also update a user progress profile based on the user's performance and corresponding analysis.

One example of JSON time coding that may be used by the performance analysis module PAM 106 is provided below:

### Performance Analysis Module—Example PAM Time-Coded JSON Format:

```
{
  “valid_response”: true,
  “performance_metrics”: {
    “accuracy”: {
      “score”: “0-100”,
      “explanation”: “Detailed analysis”
    },
    “time”: {
      “score”: “0-100”,
      “explanation”: “Detailed analysis”
    },
    “technique”: {
      “score”: “0-100”,
      “explanation”: “Detailed analysis”
    }
  },
  “key_moments”: [
    {
      “timestamp”: “MM:SS”,
      “description”: “Detailed observation”,
      “significance”: “Concise summary”,
      “observations”: {
        “example_one”: [ ],
        “example_two”: [ ],
        “example_three”: [ ],
      }
    }
  ],
  “annotations”: [
    {
      “timestamp”: “MM:SS”,
      “annotation”: “Concise observation”,
      “type”: “stick_technique|rhythmic_accuracy”,
      “position”: “upper_body|face|hands|drums|general”
    }
  ],
  “highlight_clip”: {
    “start_time”: “MM:SS”,
    “end_time”: “MM:SS”,
    “reason”: “Context explanation”,
  }
}
```

### Curriculum Management Module:

In some embodiments, a Curriculum Management Module (CMM 104) may provide the lesson-logic backbone of the system. The CMM 104 may encode a curriculum as a deterministic sequence of machine-readable lesson items with associated constraints, milestones, and allowed tools, and may incorporate conditional logic, branching pathways, and real-time adaptation based on milestone attainment or user performance, and may coordinate with the core system 102 and related modules to govern when content is introduced. By directing both lesson conversational flow and media handoffs, such as between avatar-led dialogue, interactive tools, and pre-recorded mentor media, the CMM 104 may keep sessions deterministically on track while permitting controlled, lesson-aware adaptation based on user state and time. This framework may improve lesson reliability and progression, reduce hallucinations, and enable mentor-authentic, seamless media integration across mentors and domains, as further described below.

In some embodiments, the curriculum management module (CMM) 104 may be integrated with the core system 102 and may be integrated with the lesson flow. In some embodiments, the CMM 104 may help ensure that the lesson provided to a user remain on track by generating and monitoring the curriculum via the lesson structure system (FIG. 13), and adapting the lesson structure content based on the user's performance, teaching style, goals, etc. The CMM 104 may also work with core system 102 to include content integration like mentor interactive tools, media, etc. in coordination with the avatar director module 114. The core system 102 may handle this interaction, which may allow the lesson curriculum to dictate the lesson's structure while still providing the flexibility to adapt to the user's needs. The CMM 104 may achieve these capabilities through the lesson structure system and methods for seamless media integrations, as further described below.

### CMM 104 Lesson Structure

FIG. 13 shows an example embodiment of a graphical user interface (GUI) for an admin console 700 that may be used for designing or programing aspects of the virtual mentor system 100, such as the lesson structure system used by the CMM 104. In some embodiments, the creation and storage of lesson structures may be achieved via the admin console 700. In some embodiments, the admin console 700 may be used for lesson function call creation, such as in 724.

In some embodiments, the admin console 700 may be a streamlined portal for admins to submit and track aspects of the system 100 for each mentor, which may include generating the different mentor profiles, curriculums, lesson structures, tools and tags (and their schema definitions), knowledge base formatting, user progress database, etc.

In some embodiments, the mentor profile may include knowledge base training data input and storage. Mentor curriculums may include each lesson description and lesson structure as well as the bank of pre-recorded videos/media applicable.

At 702, an administrator may create a lesson structure for use by the core system 102 in a given session, optionally in consultation with the real-life mentor and with reference to pre-session outputs from the Mentor Knowledge Base 126. The lesson structure may be authored from scratch in the Admin Console 700, imported or exported, or autonomously generated by the CMM 104. The lesson structure, as depicted in FIG. 13, may define a step-by-step curriculum while permitting flexibility and tailoring of responses based on user skill level, preferences, and context. Related media and other session assets may also be created and stored in the Admin Console 700 for use within the lesson.

At 704, the CMM 104 may autonomously generate lesson structures. A CMM 104 curriculum-generation engine may use exemplar lesson frameworks, predefined rule sets, and mentor-scoped context, such as materials and constraints retrieved from the Mentor Knowledge Base 126, to produce a well-formed lesson script from a high-level specification (e.g., “Create a 15-minute beginner lesson on rock drumming for Mentor X”). A dedicated generate-lesson-structure endpoint may manage this process to accelerate authoring and ensure adherence to the required structural syntax for reliable execution.

In some embodiments, the lesson structure shown in 700 (as may be relayed by the CMM 104 to core system 102) may be a defined sequence of lesson item objects. The sequence may be represented as an array of machine-readable items that may establish the order, with the mentor model/core system 102 echoing the current position in its runtime schema response. Each lesson item, such as lesson item 3 depicted in whole at 706, acts as a single, atomic step in the lesson and may include a set of machine-readable properties that orchestrate the mentor model's behavior.

In some embodiments, each Lesson Item may represent a discrete step or instruction in a mentorship session. The tagging properties relayed with each step may further strengthen the reliability of the core system 102 responses and avoid confusing data inputs/outputs. The lesson structure item may include properties such as an index number at 708, content at 712, difficulty level at 714, tags such as at 728, function call integration at 718, milestone identifier at 720, time constraint at 722, media integration at 730, among other tags.

In some embodiments, the index at 708 may be a unique number identifying the lesson item (e.g., <Index>1</Index>). These index numbers may be a sequence determined by an array order. In some embodiments, the index may determine the order in which lesson items are processed. For the purposes of dynamism, the order of these lesson items may be reordered, replaced, or modified manually and/or autonomously by the CMM 104 in-session as illustrated with the sortable tools that may be used to modify the lesson sequence around 708. Each lesson item may enumerate the allowed tools, and the mentor model's core system 102 runtime output may be restricted, in some embodiments, to either a conversational response or a function call machine readable object. This contract may help prevent or limit the core system 102 from generating conversational text when it should be triggering an action, and vice versa. In some embodiments, valid runtime forms include:
text: Indicates that the response should be plain text (e.g., delivering the content specified at 712).
function call: Indicates that a function should be executed; the function name should match one of the item's allowed tools and the arguments should conform to the function's schema defined for the mentor, such as the function configured at 724. For example, in lesson item 4, the system may invoke the display_notation function (as listed in the lesson item function at 718 and configured as a function in 724).

Content, such as at 712, may contain the instructions on what should be delivered to the user by the mentor model, and may provide context or guidance for generating the response for the current step. Content may function as a scoped, step-level prompt within the broader lesson framework, expressing pedagogical objectives and constraints to guide generation rather than relaying a verbatim script. Difficulty Level, such as the “beginner” classification at 714, may be optional in some embodiments, and may provide a measure of the lesson item's complexity, which may be selectively modified by the CMM 104 based on the user's actual skill level. Recursive items, such as at 716, may be optional, and may be a tag that indicates a lesson item can be repeated as necessary until the core system 102 determines it may be appropriate to continue with the session flow based on predetermined factors from the lesson structure 700. Recursive points in the lesson may be when there is expected to be back and forth between the user and mentor before proceeding to a certain lesson item, such as the drum mentor instructed to break down a groove step by step in the recursive item at 716. In this example, the drum mentor may opt not to proceed to index 5 which includes media of the media, until it deems the groove was sufficiently broken down to the user and they are on the same page.

Function calls, such as the display notation function listed at 718 in lesson item 4, may be a structured object defining the name of a function to be called which may correspond to an argsSchema that may dictate the parameters and their types (e.g., {“paramaters”: {“type”: “exercise”}}). An example of the schema configuration can be seen at 724 for the notation function used at 718 in lesson item 4. The system may validate the core system 102 output against this schema, helping to ensure robust and error-free tool integration. Function call tags may be optional, and may sometimes only be present when the lesson item is a function call. Function call may include two sub-elements: Name: The function name to be called, which should match one of the mentor's allowed function names, as attributed in the admin console. ArgsSchema: A machine-readable schema that may define the properties and types for the arguments, such as the Parameters and Enum Values in 724. For example, a function call for a metronome might require an argument schema such as: {“tempo”: {“type”: “number”}}, resulting in a response such as 726 by the core system.

TimeConstraints, such as what may be configured using the clock icon 722 in lesson item 3, may be optional, and may define when the lesson item should be executed relative to the remaining session time. In some embodiments, the core system 102 may receive periodic time-remaining system messages from the Session Manager Module 103.

Tags may be an array of metadata tags that control various sub-systems, such as kbr_enabled at 710 to permit or mandate knowledge base retrieval via KBR 105.

Tags may be optional in some embodiments. Each lesson item, when executed, may include an array of formatted tags that may provide extra metadata. These tags may help the system and admins track conditions or processing rules.

Examples of Tags, such as what might used at 728:
Tailoring instructions: Used to indicate how the mentor should configure a response or tool, such as the BPM of the metronome tool in 728.
user context: Used to indicate that the response should take into account specific information about the user's profile.
app knowledge: References pre-loaded training materials or system knowledge that 102 should integrate naturally. It may also force a KBR 105 retrieval (e.g. at 710).

In some embodiments, lesson items in the curriculum that contain media content may have a special configuration to ensure seamless integration. The media configuration may provide explicit instructions, in coordination with the Avatar Director Module 114, on the type of content the media may be tagged as, as well as how the transition may take place from the digital mentor to the avatar, such as the video of the demonstration of the groove in lesson item 5 at 730, following the conversation flow from earlier lesson items, in this case either 4a or 4b.

Milestones may be mandated in the lesson structure at certain key stages, for example lesson item 4 at 720 that marks the moment in the lesson an exercise has been introduced. The milestone may appear in visual feedback on screen for the user, and the core system might have additional responsibilities to fill in the milestone comments to the user for lesson items marked with these tags. The CMM 104 and/or core system 102 might also autonomously create milestones in-session based on user progress, even if not dictated in the lesson structure.

In some embodiments, the aforementioned tags may influence or mandate the core system 102 to trigger knowledge base retrievals via KBR 105 to retrieve relevant materials pertaining to that lesson item, along with a KBR directive targeting the query type and context. This may be done using the KBR 105 retrieval parameters described further below in reference to FIGS. 7A and 7B.

In some embodiments, responses may be further personalized or adjusted based on the visual input received from the user with each message. For example, the system may detect the type of drum set the student is using, or recognize if they only have a practice pad, and then tailor the feedback and function calls accordingly to suit their specific setup.

In some embodiments, the corresponding response from the mentor model/core system 102 may be a machine readable, structured schema based on the active lesson item content and tags, such as the response depicted at 726 from the lesson item 6 with tags depicted at 728. The structured format may enable deterministic orchestration of conversational content and tool execution within a controlled lesson structure.

In some embodiments, responses for the core system 102 may be formatted as a standardized schema that, as a result of the lesson structure system described herein, may (i) convey conversational text or (ii) introduce a function call, with each response deterministically associated with a specific lesson item.

The standardized schema may allow every lesson item to be processed sequentially so the system 102 may interpret responses without ambiguity. The core system 102 may validate each assistant response against the active lesson item's metadata, permitted functions, and argument schema. In such embodiments, the virtual mentor may better adhere to the lesson structure; appropriately introduce content (e.g., calling tools where permitted, or submitting a conversational response when applicable); identify key moments in the session; consider time constraints; dynamically adjust text content and tools based on user skill level; and integrate knowledge retrieval while still adhering to the curriculum, etc. If the core system 102 proposes an output that violates the active lesson item's constraints (e.g., incorrect index progression, disallowed function, improper formatting, or mismatched difficulty), the CMM 104 and/or session manager 103 may gate the response, maintain the current lesson_item_index, and issue a system message instructing regeneration consistent with the item's metadata and permitted tools.

In some embodiments, based on the CMM lesson structure 700, a response for the core system 102 may include one or more of the following schema properties:
lesson_item_index (number):
a. Indicates the unique index of the current lesson item within the overall lesson structure.
b. Is sequential and remains within the defined range of the lesson structure.
c. The same lesson_item_index may be reused to indicate that such responses belong to the same lesson step and do not advance progression.
text (string, optional):
a. Used when the active lesson item is of type text.
b. Contains the actual message content directed at the user.
c. When using the “text” key, the response should not include a “function_call”.
function_call (object, optional):
a. Used when the active lesson item is of type function_call.
b. Structured with two keys:
   i. name (string): The function to be executed. In some embodiments, the value must match one of the functions whitelisted for the active lesson item, as defined by the lesson structure.
   ii. args (object): The arguments for the function. In some embodiments, args are validated against the parameter schema declared for the whitelisted function in the lesson structure (e.g., tempo as a number; exercise name as a string). If either the function name is not permitted for the active item or the args do not conform to the declared schema, the core system 102 may reject the response or request correction.
Mutual exclusivity:
a. The “text” and “function_call” properties may be mutually exclusive within a single response.
b. This clear separation may ensure that function calls are reliably introduced when expected and that conversational responses are delivered without omission, thereby preventing ambiguous mixed-mode outputs.
kbr_enabled (boolean, optional) and kbr_query_directive (string, optional),
a. In some embodiments, the schema may further include a knowledge retrieval gating mechanism, such as with reference to the in-session KBR retrieval process depicted in FIG. 7B.
b. The kbr_query_directive (if present) may be a concise directive describing the targeted knowledge sought (e.g., “tips for relaxing wrist tension”).
c. A knowledge retrieval turn does not advance the lesson; subsequent responses that incorporate retrieved knowledge may reuse the same lesson_item_index.
d. In some embodiments, certain lesson items may mandate KBR; in such cases, a knowledge retrieval turn must precede any function call execution for that item.

### Auto-Response Tagged Responses:

In some embodiments, immediately following a specified lesson index or function call introduction, an auto-response text message may be sent. This message explains the action taken (e.g. following the metronome introduction at 728). In some embodiments, sequential processing may occur because both responses may share the same lesson item index (6) to indicate that they belong to the same lesson step. Mutual exclusivity of type may be provided. For example, the first response may include only a function_call object, while the second response may contain only the text property. In some embodiments, the auto-response tag in the lesson item tagging syntax may cue the system to follow up the function call introduction with a message that explains the action and guides the user.

### Conditional Branching:

In some embodiments, such as at phase 732 of the lesson structure, the virtual mentoring system 100 may include conditional branching. The branches may be pre-determined, and the lesson flow my allow for non-linear progression based on, for example, user skill level and preferences. In some embodiments, the system 100 may incorporate a hierarchical “tree of possibilities” to guide dynamic lesson progression. For example, certain stages of the lesson might “branch out” into different possible avenues based on predetermined factors, such as user skill level, detection of user struggling with a technique, etc. These branches may stay under the same index of the lesson structure item but with a variant (e.g., stage 4a of the lesson after stage 4 detected a branching would be appropriate). These branches may include content and tools that may only be relevant in this section if the core system 102 detected it would be appropriate for the user to see the branched content, and may not be part of the baseline lesson structure. With this dynamic capability, certain lesson items, such as 734 at lesson item 4b for advanced users, might be optional entirely. This may allow the core system to skip over content that is not relevant to a particular user, and intelligently skip to more pertinent lesson items, while still within a structured curriculum.

### Gamified Elements

In some embodiments, the lesson structures may not be limited to standard educational-style “curriculums.” The lesson structure format may also include Q&A session style sessions, and more interactive/immersive sessions to choose from such as mock negotiations, crisis management scenarios, gamified k-12 style curriculums with interactive elements, etc., that may branch based on user input and progress. The variety of structures may be achievable and scalable due to the baseline lesson structure system 700 in place for advancing a “lesson” and may allow for session modifications to a variety of formats and experiences. An example of how the modularity of the system may work for any kind of session, and be tailored to any user's learning style, is a “gamification” style lesson for a Tour Manager mentoring session. In this example, a user may select from curriculum options, which may ask the user to roleplay as Tour Manager for an A-list artist for the day. The lesson structure may denote certain challenges (achieved through the interactive tools to be called) that test the user's adaptiveness and “on-the-fly”management skills. The lesson may structure the experience with the gamified interactive tools and videos to be called based on user progress, and their performance of these scenarios may be judged by the PAM 106.

### Dynamic Context Updates

### Real-Time Adaptation:

In some embodiments, the virtual mentor system 100, such as via the core system 102, may include applying dynamic context updates during the session. In some embodiments, the core system 102 and the lesson structure may be designed to adapt based on the current lesson item, user performance, and from system updates (e.g., remaining time in lesson). This real-time adaptation may provide for responses that may be malleable in real time based on the evolving state of the session. Context updates may be delivered via system messages to the core system 102.

### Dynamic Curriculum

The system 700 may dynamically modify or tailor a given curriculum/lesson structure to further personalize a session to a user's needs based on user input and data provided prior to the start of a given session, and/or autonomously in-session via context updates (including applicable prompt tags such as content 712, functions 718, tags 728, etc.) in advance or in-session via a specialized curriculum generation model and submit that revised input to the lesson session context, which may be relayed to core system 102. This may be the same curriculum generation model endpoint referenced earlier at 704. In such embodiments, the session context may import and properly format that lesson structure schema into the lesson structure and use it or update it for the lesson. In some embodiments, this pre-session process may reference and modify existing “templates” of pre-determined curriculum lesson structures, but it may also generate entirely new lesson structures.

The CMM 104 generation model used to generate this output may be meticulously trained on prior lesson structures so it may have the context to format the schema and lesson content properly, such as how to properly phrase lesson content instructions as desired (i.e. not using too much imperative language which affects the reliability, how to balance between natural interaction and the introduction of tools at the appropriate time, how to include the proper function calls from the available mentor options, etc.). The CMM 104 may have access to other modules, such as KBR 105, PAM 106, to have relevant context for generating a tailored curriculum to a particular user.

### Milestone-Based Flow

In some embodiments, certain lessons may include milestones with specific conditions and actions that may dynamically determine next steps based on user input and progress. A certain milestone, for example at 720, might warrant the branching of a curriculum, such as described above. In another example, a user that may be struggling with a certain drum technique and failing to reach a certain PAM 105 score (as described above with reference to FIG. 5 and/or FIG. 12) might trigger the branching of the lesson to focus on the technique more in-depth and potentially include a video of the real-life mentor talking more about that groove or how they approach situations where they struggled similarly. In some embodiments, the milestone-based flow may be achieved via tagging in the lesson index numbers, which may correspond to a “branched” lesson route.

### CMM 104 Seamless Media Integration:

In some embodiments, the CMM 104 may provide seamless media integration that intermixes pre-recorded, pre-rendered, or dynamically generated mentor media with the virtual mentor interacting with the user. In some embodiments, the system 100 may provide a hybrid experience, enabling seamless handoffs between interactive guidance and authentic media of the mentor in segments. In some embodiments, the system 100 may address this by using structured curriculum management to designate lesson-aware cue conditions and handoffs so the session may introduce the real mentor's media where it adds pedagogical value, while the virtual mentor may provide live guidance elsewhere. In coordination with the core system 102 and modules such as the sessions manager 103, the avatar director module 114, and the media integration module 116, the CMM 104 may choreograph these transitions and may prepare target media with low latency, enabling hybrid experiences without perceptible seams or visual disruption, as further described below.

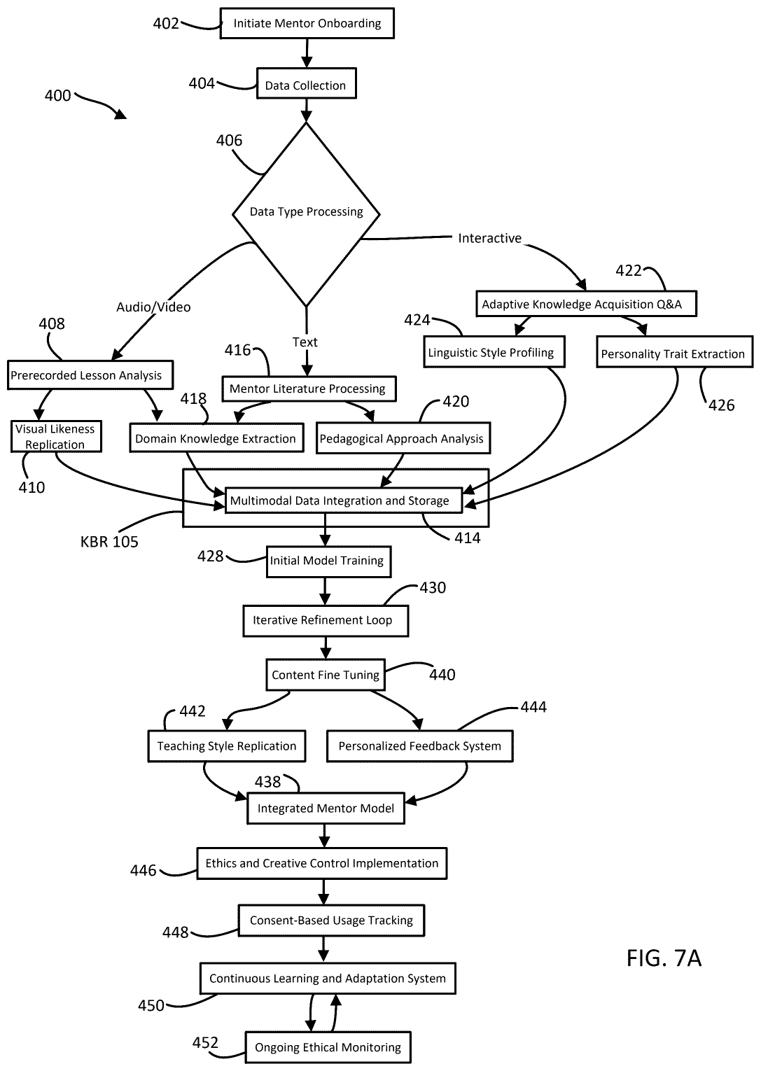

FIG. 6 includes a flowchart illustrating an embodiment of method 300 of seamless interactive media integration, such as between the curriculum management (CMM) module 104 and the core system 102. While the method 300 is shown as a single process, it is contemplated that the method may be used repeatedly or in an iterative manner as appropriate and as determined by the core system. At 302, the method may include analyzing (such as by the core system 102) a user action. For example, the user 67 may use the user equipment 69 (if any) or otherwise perform a task in the environment 50 that may be observed by the one or more sensors and other components connected to the computer 55. At 306, the curriculum management module (CMM) 104 may process a technique or other performance metric used by the user, and may, at 308, access a mentor-specific curriculum. The CMM 104 at 308 may reference the aforementioned curriculum via the lesson structure system (FIG. 13) and may also consult the KBR 105 (FIG. 7B) to retrieve relevant mentor context before opting to integrate content or not. In some embodiments, the mentor-specific curriculum may have been determined based on training data related to the real-life mentor that the virtual mentor may be replicating so that the virtual mentor (and any media integrations) may be providing a curriculum that may be based in lesson plans, styles, techniques, experiences, etc., of the real-life mentor.

At 304, the system may evaluate whether content integration is appropriate. If not, then at 310, the system may determine to continue with a lesson or other virtual mentorship, such as by continuing a main lesson flow via the lesson structure. If yes, then the CMM 104 may, at 312, evaluate the user's performance against curriculum milestones. In some embodiments, those curriculum milestones may be based on the mentor-specific curriculum identified at 308. These milestones may be mandated in the CMM 104 lesson structure, such as via the lesson index content and milestone tags and/or the CMM may at any point dynamically invoke this step during a user performance. In some embodiments, the evaluation may include, at 314, identifying a specific learning need and, at 316, assessing skill gaps. For example, the CMM 104 may identify that, for example, a user learning to play a musical instrument has trouble with a particular skill, such as maintaining rhythm or playing notes cleanly. Those skilled in the art will recognize that many other skills or learning needs may be identified within the meaning of the disclosure. At 318, the curriculum management module 104 may consider the particular learning style of the user or of the mentor as part of the performance evaluation in the context of the mentor-specific curriculum. The CMM 104 may also consult KBR 105, with a particular focus on retrieving user context and mentor feedback content, as relevant considerations when making these determinations.

At 320, the system (e.g., the core system 102) may receive the results of the evaluation from the CMM 104 and may determine an optimal content type to provide to the user, e.g., via the computer 55. For example, in some embodiments, the system may determine the optimal content type through a combination of curriculum-based rules passed via the lesson structure and dynamic adaptability. Similar to how the core system 102 interprets results from the PAM 106, the core system may rely on the CMM 104 to intelligently decide which content type may be most appropriate for the next part of the lesson. In some embodiments, this decision-making process may consider user preferences, progress, and performance metrics relayed from the CMM 104 lesson structure, KBR 105, and/or PAM 106. For instance, the system might be prompted in a lesson structure item, such as depicted at 730 in FIG. 13: “After the user confirms they're ready to see you demonstrate the groove, call the exercise video.” In this example, the CMM 104 via the lesson structure Index number 5 may mandate this video integration dictated by the display_exercise_video tag, relying on the mentor model (core system 102) to determine when it may be appropriate to proceed.

In some embodiments, the system may determine that media of the real-life mentor (or the virtual mentor) may be appropriate for the next part of the lesson. If so, at 329, the system may select relevant media. For example, the relevant media may include a video of the real-life mentor discussing or demonstrating a particular skill, relaying an anecdote specific to the real-life mentor, a real-life concert clip, interview segment or other media sourced from the public domain, documentary style shorts, etc. In some embodiments, the relevant media may be all or partially a virtual mentor clip generated by the system using generative tools. In some embodiments, the virtual mentor clip may be generated on the fly in substantially real-time to fit into the particular portion of the lesson, or may be pre-recorded for potential use by multiple users in similar points of their curriculum. In some embodiments, the particular selected media may be relevant to the portion of the curriculum being experienced by the user as determined by the lesson structure in the CMM 104. In some embodiments, there may be several variations of available media clips that may be selected by the method 329 based on factors like skill level, progress, etc. (e.g. display_exercise_video_beginner, intermediate, advanced). In some embodiments, once the system selects the relevant media, at 330, the system may generate media integration function calls that may provide access to the selected media, e.g., by the computer 55. The system may also, at 332, identify script cue in/out points in coordination with the virtual avatar response. For example, the system may identify when in the response to the user to introduce the selected media clip (or portion of a media clip). At 334, the system may integrate the selected media content into the user interface on the computer 55 as part of the mentor response.

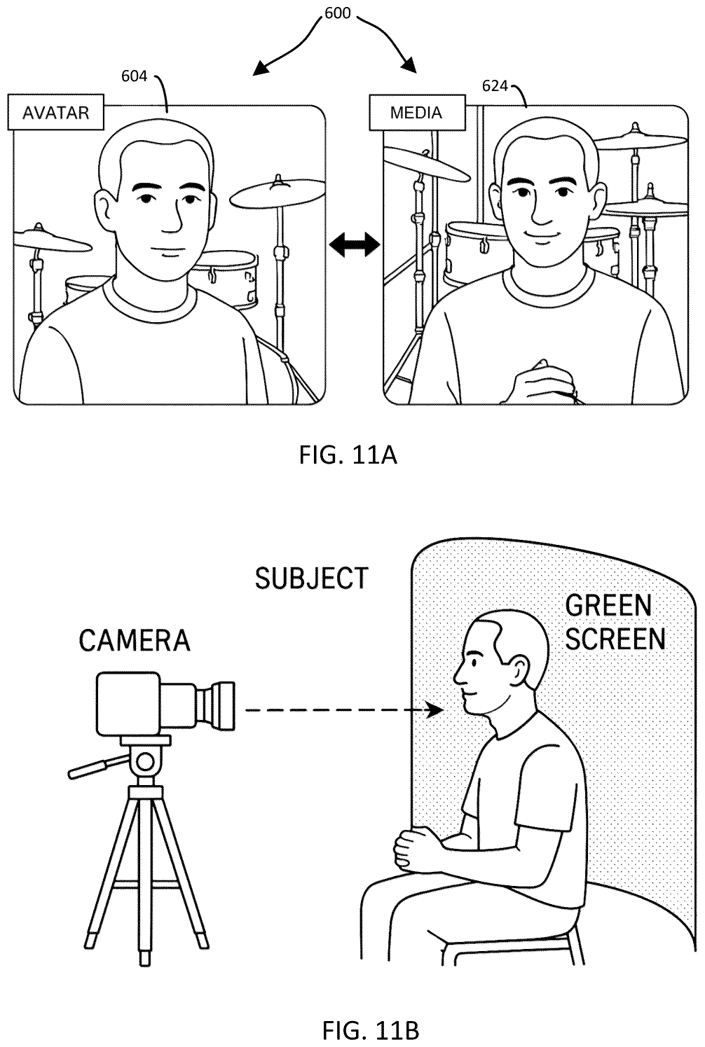

In some embodiments, when selecting relevant media, the system may coordinate a seamless transition from the avatar to the media through the Avatar Director Module 114. This process may involve preloading the media, synchronizing the preloaded media with the avatar's actions, and aligning transitions to maintain a smooth and contextually appropriate flow from interactive dialogue to media playback. In some embodiments, the Avatar Director Module 114 may provide formatted animation instructions (such as a “head turn” that will align the virtual avatar position with the position of the real-life mentor in a given media clip, such as represented in FIG. 11A) and layouts to the virtual mentor for integration. In some embodiments, script cue in/out points may be determined by the system's prompts, such as the content in a given lesson index item, guiding the avatar on how to introduce and integrate media elements contextually within the lesson flow. For example, the CMM 104 may design prompts to direct the avatar precisely on what to say when introducing a media function call, ensuring seamless media integration in coordination with the Avatar Director Module 114. After the media plays, the Avatar Director Module 114 may send a status update, such as a “carry on” system per the session manager 103 message to the core system 102, signaling the avatar to respond as if it has personally demonstrated the technique, enhancing the immersive experience.

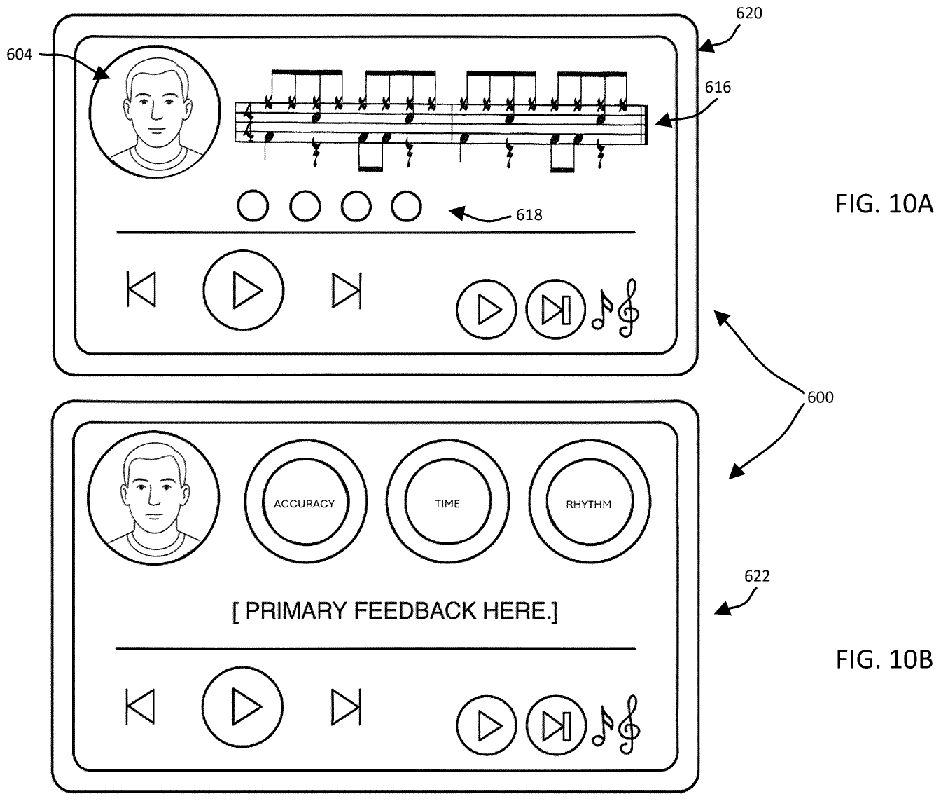

Alternatively, at 320, the CMM 104 may determine that an interactive tool may be appropriate for the particular point of the user's learning or mentoring experience. For example, the interactive tool may be a skill-building drill or exercise, a metronome for musical practice such as depicted in FIG. 10A, or some other type of practice or lesson for the user to learn from based on the evaluation performed above. At 322, the system may select and configure an interactive tool. In some embodiments, the selection of interactive tools may be based on the curriculum outlined in the CMM 104 and relayed to the core system 102. Each lesson may have predefined guidelines indicating when specific tools should be incorporated to align with the lesson's objectives, as aforementioned in the lesson structure system in FIG. 13. For example, a particular curriculum might specify to introduce a metronome only after an exercise video has been played, or to prompt the user to pitch a new TV show concept only after a famous writer mentor discusses their brainstorming process. However, the CMM 104 maintains flexibility, allowing the core system 102 to make adjustments based on user needs or progress. In some embodiments, the system may modify the lesson flow dynamically, such as by delaying interactive tools or media if the system detects the user may need more time or additional assistance, or conversely skipping over stages if the user already excels at them.

One illustrative example of a function call for configuring the interactive tool in an embodiment for a virtual mentor teaching a music lesson may resemble: {function_call: start_interactive_metronome(tempo=X)}, where ‘X’ may be replaced with an appropriate tempo based on the user's proficiency level (e.g., 60 BPM for beginners, 90 BPM for intermediate, 110 BPM for advanced). With such function calls, the core system 102 may tailor the interactive tools to the specific needs and skill level of the user. The system may also dynamically adjust the configuration of interactive tools in real-time based on the user's performance, such as by modifying the already assigned BPM if the system detects the user is struggling or excelling with the current tool.

In some embodiments, the system may, at 324, generate function calls for the interactive tool selected. At 326, the system may match an interactive tool to the particular learning need that may have been identified at 314. The system may also adjust the difficulty level of the learning need at 328 based on the curriculum management module 104 evaluation, for example. At 334, the system may integrate the interactive tool content into the user interface (e.g., via the computer 55) to be provided as part of the user experience. At 336, the system may render the content (whether media or interactive tool) into the user interface.

In some embodiments, the CMM 104 lesson structure may include a tagging system for automatic function triggering in specified lesson items, such as with functions depicted earlier in FIG. 13. When these tags are tied to a lesson structure item, it may tell the system to automatically trigger that specific function when that lesson item is reached without the need for the core system 102 to invoke them directly. This system may be used when incorporating certain triggers for media, interactive features, system functions, etc. The CMM 104 may use these triggers contextually based on the conversation flow between the user and the system (i.e., virtual mentor). In some embodiments, the system may intelligently parse the schema of the core system 102 generated responses to include function calls that may, for example, trigger the display of pre-recorded content or interactive elements. This may allow the mentor model to initiate specific actions, such as displaying videos or notations, directly into its natural language responses. These approaches may help provide contextual relevance for the mentor model. Such integrations may provide a more reliable user experience, reducing the burden on the core system 102 having to manage countless tools and system functions calling when not necessary for dynamism, and further helping make the transition between pre-recorded and contextually appropriate generated content indistinguishable to the user.

### Mentor Knowledge Base:

In some embodiments, a Mentor Knowledge Base 126 may provide the foundation for mentor-authentic instruction at scale, with synthesized outputs stored for session use in a Knowledge Base Retrieval module (KBR 105). Mentor training materials and example feedback libraries may be acquired and structured with metadata, and an automated alignment harness may benchmark and gate model behavior against mentor style and policy constraints. In-session, the KBR 105 may perform controlled retrieval so that relevant mentor-scoped context is injected to the core system or other sub-modules when appropriate. This arrangement may distinguish the knowledge base system from conventional bulk-context designs and may provide measurable authenticity and compliance controls, as further described below with reference to FIGS. 7A and 7B.

In some embodiments, the Mentor Knowledge Base 126 may prepare and train mentor models in the system to be designed to replicate the unique teaching styles and knowledge of the real-life mentors on which the virtual mentors may be based. The results of these pre-session processes may dictate the core system prompts and/or model fine-tuning for the core system 102 and synthesized results may be stored in the Mentor Knowledge Base Retrieval Module (KBR) 105 for use in-session. These modules may be designed from end-to-end to ensure alignment with the mentor's authentic teaching styles, including storing examples of performance analysis feedback in their respective domains, and accurate persona capturing through training materials. The mentor models may also be fine-tuned in coordination with the real-life mentor to help cover any gaps in the model's knowledge, and to align the model's output of responses with a variety of potential user scenarios. This may help align the mentor model with the mentor's evolving methods. In some embodiments, the database of knowledge from prior conducted knowledge base module 126 model training and adaptive Q&A's with the mentor may be integrated with the curriculum management module (CMM) 104. Comprehensive training data may be used to train the mentor models, such as by using a rich dataset that may include pre-recorded lessons, method books, relevant literature from the real-life mentors, etc. This data may form a foundational base for replicating the real-life mentor's teaching style and philosophy. The knowledge base retrieval module 126 may invoke an auto-ingest process that constructs training materials and feedback templates, assigns mentor-defined tags, and embeds these assets into mentor-scoped namespaces for fast, filtered retrieval. The console may present mentor-defined tag categories, each with an applicability set. The system may implement a dual-layer tagging architecture that distinguishes between system-wide foundational tags and mentor-specific customizable tags. System-wide tags may provide baseline categorization across all mentors, which may include standardized categories such as “Response Tone,” “Instructional Focus,” and “Analysis Context.” These system tags may ensure consistency and interoperability across different mentor domains while maintaining pedagogical coherence. Mentor-specific custom tags may enable domain expertise differentiation and personalized teaching approaches. Each mentor may define and extend custom tag categories tailored to their field. For example, a drum mentor may create tags for “Groove Types” or “Stick Techniques” while a tennis mentor might use “Court Position” tags. In some embodiments when knowledge gaps are identified in the mentor model, the knowledge base module 126 may perform an adaptive knowledge acquisition Q&A. This process may conduct dynamic interviews with the real-life mentors, extracting detailed insights into their teaching style, philosophy, and responses to various scenarios. In some embodiments, the interviews may be designed to identify any gaps in the mentor model's knowledge of the mentor or curriculums that may not have been covered in other training materials. For example, this may include requesting that the real-life mentor respond to various lesson scenarios. The data collected from the interviews may then be structured as training materials and feedback queries into a proprietary knowledge base known as the KBR 105 that may inform the mentor model's feedback generation and lesson flow, which may help ensure that the mentor's unique approach may be consistently reflected.

In some embodiments, the knowledge base module 126 may reference pre-recorded lessons and transcripts of the real-life mentor as part of the mentor model training, or as training data. In addition to video analysis, transcripts and audio from pre-recorded lessons can provide context for the tools used by the mentor model 102 to deliver feedback to the user that may be both authentic and aligned with the real-life mentor's teaching, playing, or other performance styles. In some embodiments, such sources may be used to fine-tune the virtual mentor's responses to help the virtual mentor mimic the real-life mentor's approach accurately. In some embodiments, the results of these training processes may be used to train the mentor model 102 before lessons with users may be conducted. In some embodiments, the data from this training may be stored in the KBR 105 and may be drawn upon in-session by the core system 102 and/or sub-modules CMM 104 and PAM 106 as appropriate for a particular lesson.

FIG. 7A shows a method 400 of an embodiment of the Mentor Knowledge Base Module 126 for virtual mentor training that may include capturing the real-life mentor's likeness to help provide a photorealistic virtual mentor and authentic mentor model embodied by the core system 102. In some embodiments, the method 400 may take place prior to a user session. In some embodiments, the method 400 may be used to train the mentor model's core system prompts, KBR 105 materials, and tools that may function to provide bespoke, virtual mentor lessons to users. At 402, the system may initiate mentor onboarding, which may include initial identification steps, identifying data, etc. At 404, the mentor knowledge base module 126 may collect data relevant to the real-life mentor. As described above, in some embodiments, the mentor-related data may come in virtually any form that may be processed by the system. For example, the data may be mentor literature (e.g., lesson books, books, articles, etc.), audio and/or video recordings, or could be the results of a mentor interview or Q&A conducted specifically for the purposes of training the mentor model. These materials may also be autonomously ingested and synthesized (described above) by conducting searches of the mentor's works and teaching methods through internally retrieved or other external supplemental sources. At 406, the module may determine the data type and conduct data processing for storage into KBR 105.

For example, at 408, the system may perform a lesson analysis on prerecorded audio/video of the real-life mentor, such as lessons, videos, or other audio/video material. At 410, the system may conduct visual likeness replication which may include generating a 3D avatar and/or conducting micro-expression mapping. In some embodiments, during mentor model training, detailed sessions may be conducted to capture the mentor's facial expressions, vocal tones, gestures, and overall demeanor. For instance, capturing the mentor's typical hand movements, posture, and instructional gestures may allow the system to replicate these actions accurately in the virtual avatar. Inputs for this process may include visual data from sensors like cameras, tracking movements over time, while outputs may include motion sequences and mapped motion patterns to be used by the avatar during lessons. An example visual embodiment of the capturing process for the mentor may further resemble the depiction in FIG. 11B for the mentor capturing and virtual environment creation. At 410, the system may also extract one or more audio-visual features from the prerecorded lessons. For example, the extraction of audio-visual features may involve identifying key elements such as mentor gestures, facial expressions, body posture, and timing cues from the prerecorded lessons in the training stage. For instance, the system may extract specific hand movements, eye contact, and vocal inflections that characterize the mentor's teaching style, facial expressions, and/or other tendencies. These features may be used to inform the avatar's interactions, which helps the core system 102 accurately mirror the mentor during interactive sessions. The system may also generate temporal gesture mapping of each prerecorded video that may be stored and referred to when appropriate. In some embodiments, the temporal gesture mapping process may include analyzing the pre-recorded videos to map mentor gestures over time, capturing the sequence, duration, and coordination of movements. This process may include taking video inputs, extracting sequences of movements over time, and storing them as motion data files or metadata annotations that may then be used to train the virtual avatar to replicate the mentor's gestures accurately. This data may allow the avatar to replicate the mentor's gestures in real-time during lessons. In addition to visual likeness replication, the prerecorded lessons at 408 may also be converted to text and used for further domain and pedagogical analysis described below.

At 414, components of the visual likeness replication process (such as the audio-visual extraction and temporal gesture mapping data) may be integrated and stored for future reference, such as by the KBR module 105. The embedding and retrieval processes used by the KBR module 105 both prior to and during user sessions are shown and described in greater detail in FIG. 7B.

At 416, the system may process mentor literature from one or more literature sources (e.g., pre-recorded lesson transcripts, internet articles, digitized books or magazine articles, scanned hard copies, etc.). At 418, the system may extract domain knowledge from the mentor-related text. This may include extracting domain-specific concepts, methods, and pedagogical approaches from mentor literature, including mentor-authored sources, as well as other relevant texts. The system may identify key terminologies, teaching methods, and instructional processes specific to the mentor's expertise, which may allow the system to build a comprehensive understanding of the subject matter that informs the avatar's teaching style and content delivery. At 420, the system may perform a pedagogical approach analysis, which may include evaluating the extracted content to discern the mentor's unique teaching style, strategies, and instructional methods. The results of the pedagogical approach analysis may be structured profiles of teaching methodologies and instructional preferences, which may be stored and referenced in the KBR module 105 and passed to the core system 102 to guide the avatar's interactions and help ensure the educational content aligns with the mentor's authentic approach. In some embodiments, this process may overlap with the extraction of domain knowledge described at 418. The extracted domain knowledge and pedagogical approach analysis may also be synthesized into training data stored for later reference at 414 in the KBR moule 105. In tandem with these processes, the system may identify gaps in the domain knowledge of the mentor, which it may track for the gap knowledge enhancements further described below, such as the Adaptive Q&A at 422 and content fine-tuning later at 440. In some embodiments, the system may include a targeted gap-analysis workflow that identifies and resolves mentor knowledge gaps before or during deployment. The system may analyze previously recorded test sessions and structured analysis results to surface candidate gaps, each represented with machine-readable metadata such as a type (e.g. training material or feedback template), category, descriptive rationale, evidentiary excerpts, and source test context. In some embodiments, at 422, the system may conduct an interactive adaptive knowledge acquisition interview or Q&A with the real-life mentor that may generate realistic, student-style questions designed to elicit the gap knowledge from the mentor. Question generation may incorporate mentor context (e.g., based on the core system prompt), lesson and curriculum context, and the enumerated gaps. The system may produce natural questions per gap that reflect real learner needs (e.g., “I'm struggling with . . . ”, “What should I do when . . . ”), thereby ensuring coverage of both explanatory material and actionable response patterns. During the interview, the mentor's responses may be captured. The system may synthesize those responses into proposed assets (such as training materials or feedback templates) each with proposed titles, contents, and tags. Approved assets may be stored into the knowledge base (e.g., KBR 105 at 414) under mentor-scoped namespaces with appropriate metadata. The system may also attach provenance (e.g., which gaps the asset addresses) and may label synthesized items (e.g., a context tag indicating QA origin) to facilitate later retrieval and evaluation. Examples of the classification of training materials and analysis/feedback examples are further detailed in FIG. 7B. The system may also conduct, at 424, linguistic style profiling and personality trait extraction at 426. The results of both may be stored as multimodal data integration and storage 414 at the KBR 105. In some embodiments, working with the real-life mentor to provide realistic feedback and training data on which to base the virtual mentor may help provide a virtual mentor that more accurately reflects the real-life mentor.

Using the multimodal data integration from the training process as input, the system may, at 428, conduct initial mentor model training that may model each particular real-life mentor. In some embodiments, this may include preliminary steps to set up a mentor avatar model, including initiating the avatar's development by incorporating visual and auditory characteristics from the mentor's data. At 430, the system may perform an iterative refinement loop 430. In some embodiments, the iterative refinement loop may include content fine-tuning at 440. In some embodiments, content fine-tuning at 440 may include an autonomous testing process for verifying mentor authenticity and alignment across curriculum-driven and role-played user scenarios. The framework may run both benchmark scripts and dynamically generated role-play scripts (e.g., novice vs. advanced users, compliant vs. challenging requests, time-pressure, topic shifts, etc.) to exercise diverse conversational and performance conditions. Testing may be organized into Lesson Structure Testing, which may validate the individual curriculums for the mentor, tag-driven orchestration, time constraints, function-call correctness, and deterministic progression through lesson items; Knowledge Base Testing, which may evaluate biographical accuracy, domain depth, voice/personality consistency, and ethical boundaries, including A/B comparisons with KBR enabled vs. disabled to quantify the impact of retrieval; and Analysis Base Testing, which may verify that PAM-derived metrics (e.g., timing, technique) trigger appropriate and authentic analysis reference templates via trigger metrics (e.g., scoreAbove/scoreBelow). In some embodiments, an Adaptive Knowledge Acquisition process may be invoked when gaps are detected and may conduct the aforementioned targeted mentor Q&A to acquire missing pedagogical content or scenario coverage. Tests may execute in parallel batches with tag-conditioned variants that target specific retrieval modes, tools, and branching paths. The core system 102 may operate in a controlled testing mode for content fine-tuning at 440 to simulate full sessions end-to-end, initializing lesson context, routing KBR with query directives, invoking tools/function calls, etc. Test outcomes may be fed back to automatically refine the experience, which may include: updating core system 102 prompts (style, guardrails, retrieval directives), modifying lesson structures (reordering items, adjusting tags and time constraints, adding/removing function calls, changing branching conditions), tuning KBR 105 routing (mode selection rules, throttling, de-duplication policies, relevance thresholds), calibrating analysis thresholds (e.g., scoreAbove/scoreBelow performance metrics), and revising mentor tag taxonomies (adding/removing mentor-specific tags and applicability by template type). Iteratively, this may close the loop between evaluation and orchestration so that the core system 102 may improve accuracy, reliability, and authenticity across a variety of user scenarios while maintaining curriculum adherence.

In some embodiments, the content fine-tuning may include teaching style replication at 442 and/or generating a personalized feedback system at 444. In some embodiments, this may include a collaborative fine-tuning process with the real-life mentor to refine prompts, respond to gaps in knowledge, test responses, and integrate these with the mentor's custom mentor knowledge base so that the virtual mentor may remain authentic, adhere to the curriculum lesson structures, and provide accurate feedback with minimal or no deviation or hallucination. In some embodiments, data from the teaching style replication and personalized feedback system may be integrated into a mentor model at 438. This mentor model may form the basis for the mentor model embodied by core system 102 in-session.

At 446, the system may implement one or more ethics and/or creative control measures. For example, each individual real-life mentor may agree to different levels of use of the mentor's likeness, etc. In some embodiments, the system may include safeguards/restrictions and may also include measures in the core system 102's prompts to prevent the avatar from doing anything unrelated to the lesson at hand, in addition to violating policies, etc. to avoid showing the mentor, which may be based on the real life individual, in an inappropriate or unintended manner. At 448, the system may conduct consent-based usage tracking. At 450, the system may conduct continuous learning and adaption in conjunction with ongoing ethical monitoring at 452.

### Knowledge Base Retrieval Module 105:

While the core system 102 may be capable in some embodiments of receiving all of the knowledge base in its system prompts, using a structured KBR system, such as the in-session retrieval process in FIG. 7B, may help ensure real-time targeted, tangible context retrievals at the appropriate times, and with the highest relevancy thresholds for the user. FIG. 7B is a flow chart of the Knowledge Base Retrieval (KBR) Module 105 that may represent a sub-process 458 of the method 400 of the Knowledge Base Module 126 in FIG. 7A. The method, at 458, may represent an embodiment of how the KBR module 105 may perform multimodal data integration and storage, such as shown at 414 of FIG. 7A, and how it may later be used for in-session retrievals at method 460. In general, the KBR module 105 may integrate and store embeddings and vector queries that it may retrieve during a user session when appropriate via a selective retrieval-augmented generation process with mode-based routing. In some embodiments, such methods may be used for retrieving prior stored content including training data context for the mentor, examples of mentor's analysis-based feedback, user progress context, prior PAM 106 results, performance-based technique comparison to benchmarks, etc. The system may classify the materials stored in the KBR module 105 in three distinct classifications: Training Materials, Analysis/Feedback, and User Context. These classifications may be synthesized from the results of the processes further laid out in FIG. 7A.

At 462, the method may include pre-session processing, such as material tagging and embedding at 464 related to mentor materials, and user context embeddings 466 related to a user profile. Tagging at 464 may include custom tags per mentor (such as the custom mentor-tags referenced earlier), associated as metadata with all the materials, ensuring the most targeted materials are both retrieved by KBR 105, and referenced by core system 102 for the session. Examples of custom tags per mentor include skill/context tags, correlated function tags for materials associated with mentor-specific tools, and optional metric triggers for analysis-specific feedback. These filtering configurations may help contextualize and optimize the most relevant materials for the KBR 105 in-session (e.g. using correlated functions to prioritize certain materials with functions called by the core system 102 like a recording exercise, custom PAM 106 metric scores like above/score below thresholds for analysis-based retrievals, etc.). Every mentor may have a custom bank of tags associated with their domain and expertise that are used across the knowledge base, helping optimize the scalability of the retrieval process for a variety of bespoke mentor domains. These mentor-attributed tags may be auto-generated by the KBR at 464 or manually attributed. User profiles stored at 466 may be configurable for different mentors to ensure the user content stored pertains to the domains of that mentor. For example, the user profile and context stored in the KBR 105 at 466 for a drum mentor may have custom tags and datasets of user's PAM 106 drumming-specific performance data and analytics. Knowledge Base materials from FIG. 7A may be pre-embedded in the training process and stored in vector-based database indices, which may help provide that they be semantically structured, chunked, classified by material-type, and searchable, which may allow the KBR module 105 to quickly retrieve relevant pieces of context during interactions in-session. In some embodiments, metadata analysis and hybrid system processes may help ensure that only the most pertinent knowledge (provided via an XML-like structure) may be injected into a user session context without overloading token limits and the core system 102 with a saturation of context. Embedding at the beginning (during training) may help optimize the system for speed and scalability by reducing or eliminating redundant computation during real-time user interactions. In some embodiments, the KBR module 105 may use a vector query to determine the most relevant material for each mentor in real-time, allowing large amounts of material beyond token limits or server constraints. At 468, the embedded materials may be stored in distinct vector databases based on the classifier mode of the material. Retrieval in-session may be selective through routing based on this mode classification type. The routing may implement a rich system for classification into three types including Training Materials at 470, Analysis/Feedback at 472, and User Context at 474. These classifications (described in more detail below) may be stored in their own vector databases per mentor and retrieved via KBR 105 when routed accordingly. Furthermore, the retrieval process may be routed to different handlers based on the active mode.

At 460, in the actual user session, when appropriate, the core system 102, such as via the KBR module 105, may perform a vector query against the stored KBR materials to extract the most relevant content. These queries to the KBR 105 by core system 102 may work in tandem with sub-modules CMM 104 or PAM 106 depending on the context of the query and the mode routing classification. In-session at 476, the core system 102 may be responsible for triggering KBR 105 at the appropriate time, and under specified conditions (e.g. when the core system's 102 inherent knowledge base may be insufficient, when the model needs clarification on how the real life mentor would responds to a given user predicament, examples of real mentor feedback to be integrated, how to judge a user performance metrics and associate that with tangible feedback, etc.). In some embodiments, at any point in a lesson structure, the core system 102 may trigger KBR at 476 if the core system 102 determines that such conditions warrant it. Additionally, the CMM 104 lesson structure may further guide this enablement or mandate knowledge retrieval on certain lesson items and milestones, such as analysis-based feedback after a user performance. In some embodiments, the CMM 104 may also detect when the knowledge retrieval may be appropriate based on predetermined factors, such as user input character length, detection of a user question, etc. In addition to the classification of the material, when the KBR 105 may be called by the core system 102 at 476, the core system may also generate a KBR query directive which may later act as system-provided context on what kind of material and/or type of feedback is being requested. A KBR query directive may be a core system-generated field that may specify retrieval mode, correlated function identifiers, and may include a plain language description of the context the core system 102 is specifically looking to retrieve, which the KBR 105 may consult for targeted queries. An XML-like structure may be used to demarcate the boundaries between user input and this system-provided context. This may allow the system to clearly distinguish between what the user says and the additional material that informs the KBR 105 response.

At 478, the method 460 may include steps for in-session retrieval. In some embodiments, in-session retrieval at 478 may include query processing at 490, context optimization at 492, and context integration at 494. In-session retrieval may be dynamically initiated and routed to the appropriate query mode at 480. The system may include retrieval triggers, which may be curriculum-defined tags in CMM 104 lesson item's for triggering specific modes (i.e. training materials, feedback/analysis mode, or user-context mode). At 480, the system may first determine the retrieval mode based on these conditions. At 482, the KBR directive that may have been created in 476 may also be considered to ensure the proper retrieval mode is selected and the most relevant materials may be returned by the KBR 105. This directive may be submitted with additional context, such as user conversational messages, further described at 490. After the query mode is determined at 480 in consultation with the KBR directive at 482, the appropriate query mode may be selected. Examples of the types of content stored in each classification mode are shown at 484, 486, and 488. If in “training materials” mode at 484, the KBR 105 may proceed to a training materials query and may also extract correlated functions from the lesson item to refine the query if associated with a function. The system may identify which functions are to be used in the current lesson step by inspecting the lesson structure. This list of correlated functions is passed with the query, allowing the KBR 105 to prioritize knowledge chunks that are explicitly annotated as being relevant to those functions. This may help ensure that the mentor's advice may be directly applicable to the task at hand. If in “analysis/feedback” mode at 486, the KBR 105 may proceed to an analysis-based query, which may take into account performance metrics from the PAM 106. This analysis query may be filtered by metric-bound tags, such as triggerMetrics that specify a scoreAbove or scoreBelow threshold. For example, if the PAM 106 reports an accuracy score of 65%, the KBR 105 may specifically retrieve a mentor-specific feedback template designed for scores below 70%. If in “user context” mode at 488, the KBR 105 may proceed to a user context query, filtering by the type of context the KBR may be seeking (i.e. prior user PAM results, prior user responses to exercises, skill level assessments, etc.). Following the mode-routing, real-time query processing may occur at 490 where the KBR database may compare user queries (converted into embeddings) along with the KBR query directive from 482 with the pre-embedded KBR materials to find the most relevant matches. In some embodiments, this separation between initial embedding and real-time querying may reduce or minimize overhead during user sessions. In some embodiments, context may be pre-treated before the final user transcriptions based on confidence thresholds to optimize system speed and responsiveness. For example, the user might only be halfway done with speaking a sentence-“Can you tell me more about the time you struggled with X and how it impacted your performance?” by the time the core system 102 triggers the retrieval process at 476. The system may already begin seeking relevant context when the user mentioned “struggling with X” to optimize response times. The query processing at 490 may include converting KBR directives and user input to vector embedding, applying throttling and grouping, conducting vector similarity searches, and applying relevance thresholds. If no relevant content matches the threshold at 490, a fallback message may be injected back to core system 102 to maintain the session flow without any returned context, as illustrated by the arrow back to 476. The context optimization at 492 may include filtering by relevance score, combining related content chunks, formatting with an XML-like structure, and optimizing results. Context integration at 494 may include injecting knowledge to the core system 102, structured demarcation, maintaining content boundaries, and triggering response generation. At 496, the knowledge base (such as in the KBR module 105) may be updated accordingly.

### Session Manager

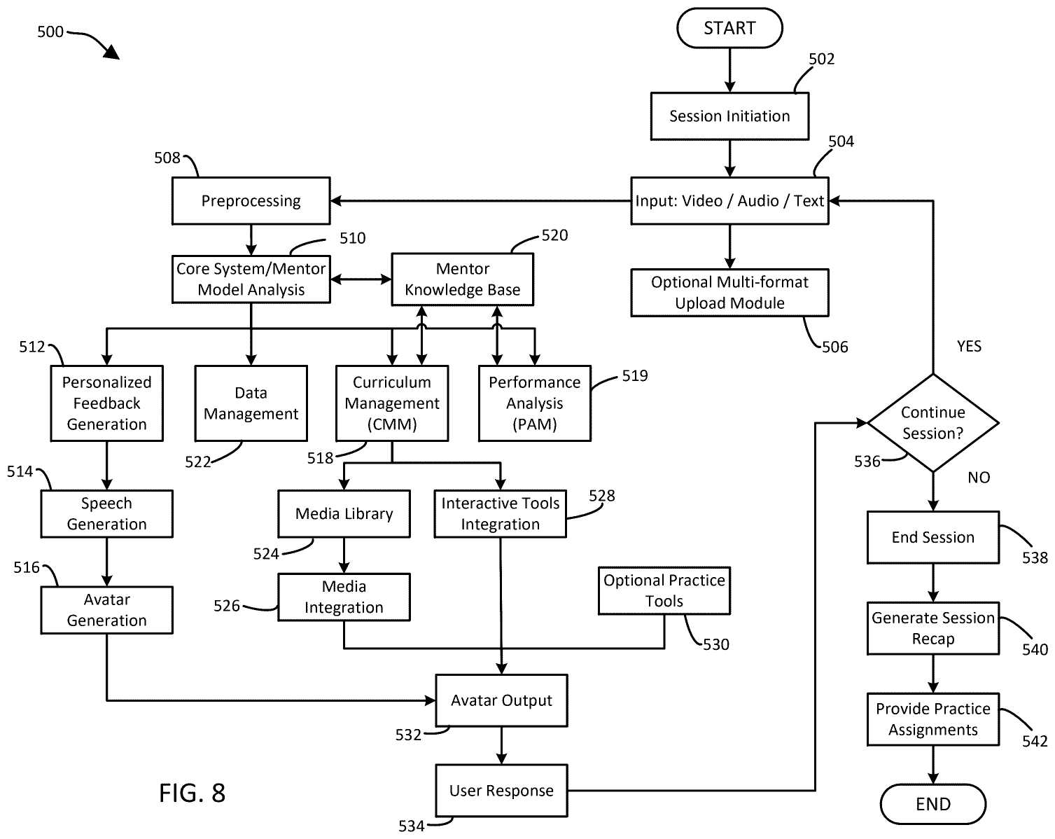

FIG. 8 is a flow chart 500 of a system architecture for operating the system for virtual mentoring disclosed herein, which may be operated by the session manager module 103. In some embodiments, session initiation may take place at 502, and the system may receive an input at 504, such as in a remote computing environment 70 via a user computer, such as the computer 55. The input may be in one or more of various formats, such as video, auto, text, other data or a combination of one or more formats. In some embodiments, the input may be received at 506 via a multi-format upload module.

In some embodiments, the input may be an uploaded file or other data, or may be video and/or audio of a user performance streamed in substantially real-time. At 508, the system may perform preprocessing of the input data. In some embodiments, this may include various tasks to standardize and optimize the data for compatibility across different modules. In some embodiments, this may include format standardization, noise reduction, and data normalization. For video and audio inputs, preprocessing may include frame extraction, audio filtering, compression, and segmentation to prepare the data for the core system 102, etc. For text inputs, preprocessing may include tokenization, language parsing, and entity recognition, which may help ensure that the data is accurately formatted for efficient processing by the core system 102. At 510, a mentor model (embodied by core system 102) may generate a response based on analysis that may take place that may involve one or more modules, or sub-modules. For example, the mentor analysis may incorporate, at 518, curriculum management via the CMM module 104 and/or, at 519, PAM module 106 analysis, as described in further detail herein with regards to FIGS. 13 and 5 respectively. At 522, the core system 102 may perform data management. In some embodiments, data management may include processes such as data storage, retrieval, and updating of user profiles to track user progress and performance. This function may involve managing data inputs from various system modules, such as user feedback, performance metrics, and curriculum progress, to help provide a cohesive and up-to-date user learning profile. Additionally, data management may involve accessing and updating the mentor profile in the CMM 104 and/or the KBR module 105, and other modules to align the instructional content with the latest mentor guidelines, which may help ensure that the system delivers personalized and contextually relevant feedback throughout the program. The formatted updates for data management pertaining to either user progress or mentor profile updates may occur via the session manager 103.

At 510, the core system 102 may elect or be mandated by the CMM 104 to consult a knowledge base in 520, such as KBR 105. In some embodiments, the mentor knowledge base may include or may be supplemented by mentor training materials such as that described with respect to FIGS. 7A and 7B. In some embodiments, the mentor knowledge base, such as the KBR module 105, may specifically focus on mentor-related elements such as pedagogy, anecdotes, teaching style, feedback examples, and background information. While the broader CMM 104, at 518, may manage lesson flow and progress tracking via the lesson structure, the mentor knowledge base in the KBR module 105 may provide mentor-specific content that may personalize the learning experience and enhance the authenticity and relatability of the virtual mentor. The KBR 105 may also be drawn upon by the CMM at 518 or PAM 106 at 519, and these components may work together to enrich the mentor's presence within the instructional framework.

At 512, personalized feedback may be generated in response to the input. The personalized feedback may include generating text or native speech output 514 and/or generating an avatar 516, such as a photorealistic virtual avatar to convey the generated feedback. In some embodiments, this may include generating a text or native speech output response from the digital mentor, incorporating the analysis conducted by the core system 102 at 510. In some embodiments, this analysis may include synthesizing inputs from various modules, such as KBR 105 queries, performance metrics from the PAM 106 and progress data from the CMM 104. The mentor model's response may drive the avatar's speech and visual outputs, coordinating with the Avatar Director Module 114 to align the avatar's actions, expressions, positioning, and timing with the personalized feedback. The response generation and avatar generation may be used in the avatar output at 532.

At 524, the mentor model may access a media library, such as via the CMM 104, to determine whether media content that may include the real-life mentor may be used. At 526, if the system determines that media should be used, the media may be integrated into the avatar output at 532, such as is described in more detail with relation to FIG. 6. At 528, the mentor model may integrate interactive tools, or include optional practice tools at 530, such as is described in more detail with relation to FIG. 6. At 532, an avatar output 532 may be generated and displayed to the user 67 via the computer 55 or another similar device. In some embodiments, the avatar output may be a photorealistic avatar of the real-life mentor in a virtually simulated mentoring environment. At 534, the user 67 may respond to the avatar output in one of a variety of ways, such as via an input device 59 of the computer 55, or by speaking via a microphone 65 or gesturing in a manner that may be observed by the one or more cameras 63 or other sensors. In some embodiments, the user response may be to perform another action in the lesson, such as playing a musical instrument or other user equipment 69.

At 536, in response to the user response at 534, the system may determine that the session should continue (e.g., continued music lesson), and may receive another input from the user at 504 and restarting the process 500. Otherwise, the system may determine that the session should not continue (e.g., the user ends the session or the lesson structure is completed) at 538. In some embodiments, the system may, at 540, generate a session recap that may include, for example, a summary of the topics and/or skills covered and/or a progress report for the user based on the mentor-based curriculum. At 542, the system may provide practice assignments for the user to complete between lessons. In some embodiments, the summaries and practice assignments may be based on the mentor-based curriculum, such as described in further detail related to FIG. 13. In some embodiments, the practice assignments may be generated directly during a user's mentoring session or sent later via a separate call from the CMM 104 or another module. This follow-up message may include an automated session recap, allow users to share progress with others on the platform, create practice assignments, schedule follow-up lessons, handle payments, etc. The CMM 104 may also share comparative user metrics to an online database, which may enable users to compare their stats with others who participated in similar sessions for purposes such as contests or other promotional activities.

### User Interface Examples

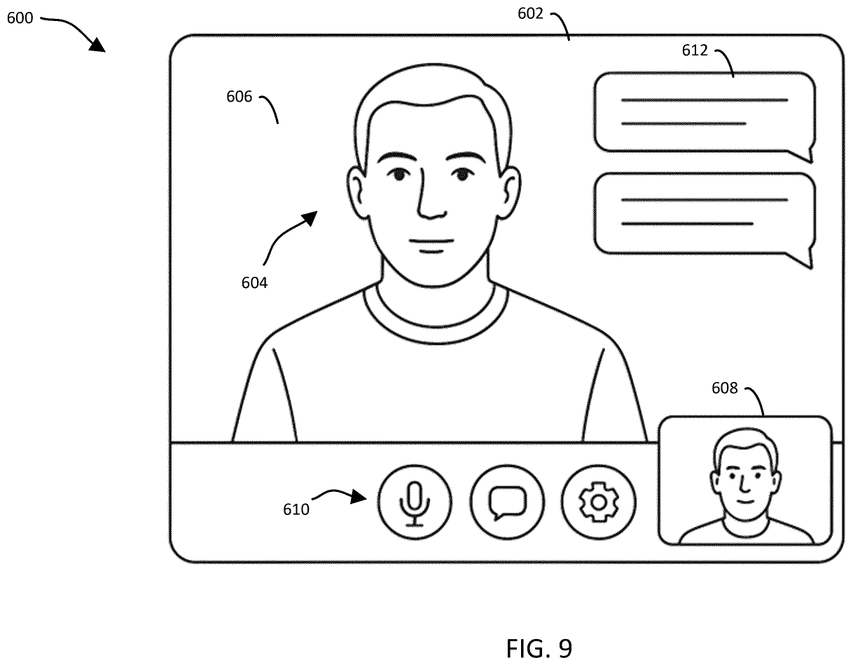

FIGS. 9-12 show example screens from an embodiment of a user interface (UI) 600 that may be used in the system for virtual mentoring described herein. In some embodiments, the UI 600 may be shown via a user computer, such as the computer 55 via the monitor 57, but those skilled in the art will understand that any suitable computing system for displaying a user interface may be used. FIG. 9 shows an example of an avatar introduction screen 602 of the UI 600 where, for example, users may receive real-time or substantially real-time feedback and interact with a visual avatar 604. The avatar introduction screen 602 may include an avatar window 606, a user feed 608 that may display the user's performance either in real-time or recording, voice interaction tools 610, and a chat history 612. Referring to FIGS. 10A and 10B, the UI 600 may integrate visual content 616, and interactive tools 618. In some embodiments, such as shown in FIGS. 10A and 10B, the virtual avatar 604 may shift to compliment the on-screen functionality. FIG. 10A shows an embodiment of a recording capture and playback tool 620 and the virtual avatar 604. In some embodiments, the recording capture and playback tools 620 may later enable users to play back exercises with integrated mentor comments overlapped, which may help facilitate self-critique and improvement through auditory and visual feedback. The recording capture and playback tools 620 may be an example of the type of content that may result from the method 200 shown and described with reference to FIG. 5. In some embodiments, the integrated mentor comments may be cued up and initiated when appropriate by the mentor. FIG. 10B shows an embodiment of a feedback and analysis tool 622. In some embodiments, following a performance input from the user, the feedback and analysis tool 622 may allow for the mentor to provide real-time, personalized feedback and detailed performance analysis. In some embodiments, this feature may be used at the mentors' discretion or based on the CMM 104 lesson structure, which may provide users with tailored guidance and actionable insights to improve their skills.

FIG. 11A shows an example of how the system may seamlessly transition from the virtual avatar 604 to pre-recorded media, such as a video clip at 624 of the real-life avatar, such as is described with reference to FIG. 6. In some embodiments, the transition may be facilitated by preloading media content in the background and utilizing avatar transitional animations directed by the Avatar Director Module 114. For instance, the avatar may perform a head turn or shift to a camera angle that aligns with the pre-recorded video, creating a fluid transition between the virtual and real-life elements. This coordination between the avatar's actions and the pre-recorded content may help the visual flow appear natural and engaging, enhancing the immersive experience for the user. The seamless transition may be achieved through precise timing, cueing, and optimized visual design, as illustrated by the arrow in the figure.

FIG. 11B illustrates an example configuration for capturing real-life footage of the mentor for later integration into the hybrid avatar-video system described in FIG. 11A. In this embodiment, the subject is positioned in front of a green screen while being recorded. The use of a green screen enables background replacement and compositing techniques to align the recorded video seamlessly with the avatar environment. This setup facilitates visual consistency and flexibility in post-production, allowing the real-life video 624 to be embedded into the virtual environment with contextual coherence.

The recorded footage may be used to match the framing, lighting, and perspective of the avatar-rendered scenes (such as avatar 604), enhancing the visual continuity during transitions. This alignment enables smooth toggling between avatar-driven segments and pre-recorded mentor footage, contributing to a hybrid immersive experience. This setup may also support techniques like head-matched cut-ins or perspective shifts triggered by the Avatar Director Module 114, ensuring that the real-life and virtual representations remain perceptually connected for the user. The footage captured, such as via the method depicted in FIG. 11B, may also be used directly for training the visual avatar model, as further described in FIG. 7A. FIG. 12 shows an example of a screen of the UI 600 for providing avatar-provided feedback to a user after a user performance, such as may be provided as a result of the method 200 shown and described with reference to FIG. 5. The UI 600 may include a playback window 611 for playing a recording of the user performance, and dynamic visual annotations 612 that may include feedback from the virtual mentor 604, timecoded to key moments in the playback. For example, in embodiments that the virtual mentor may be mentoring the user's drum technique for an exercise the virtual mentor may provide feedback on grip, posture, hand position, etc. In some embodiments, the UI 600 may include selectable options 614 such as playing back the timecoded key moment(s) from the performance, playing a full replay, or rerecording the user performance. The UI 600 may also include a performance analysis window 616, which may include the performance metric results 618 or other feedback for one or more aspects of the user performance (i.e., PAM scores).

In some embodiments, the analysis may include particular visual annotations 612 indicating notable aspects of the user's performance or areas that may need improvement. Those skilled in the art will understand that the UI 600 is an example of the UI used in the system, and other formats of user interfaces may be used consistent with the disclosure.

### Additional Technical Features of the Virtual Mentor System

### Video Optimization for Analysis

### Chunked Binary Data Transmission

In some embodiments, video data may be segmented into optimized binary chunks using a non-blocking asynchronous buffer accumulation strategy. This approach may prevent memory overflow during extended recording sessions while maintaining temporal coherence of the captured media stream.

### Base64 Transformation Layer

Prior to the mentor model(s) ingestion, the binary video data may undergo a Base64 transformation process that may preserve all metadata while ensuring compatibility with the neural processing pipeline, which may eliminate potential data corruption during transmission.

### Adaptive Codec Selection Protocol

The system may implement a hierarchical codec preference that may dynamically test device compatibility with a prioritized sequence of video encoding formats (VP8/WebM, H.264/MP4, Matroska, etc.) to ensure optimal cross-platform playback. This adaptive selection mechanism may help ensure that captured video content maintains fidelity while remaining accessible across diverse playback environments.

### Cross-Platform Playback Optimization

Key moments identified during user performance analysis may be encoded with universal compatibility parameters and delivered with device-specific playback instructions, which may ensure consistent visualization across mobile, desktop, and web platforms.

### Intelligent Bandwidth Management

The system may dynamically adjust video encoding parameters based on content complexity, optimizing for both quality and transmission efficiency while maintaining semantic integrity of the captured performance.

### Custom WebSocket and Streaming Protocol Integration

The system may achieve enhanced communication protocols via custom WebSocket and webRTC implementations for technical optimization of the stream with the avatar, and core system connection powered for the core system 102 and the other modules.

Stateless Vs. Stateful Processing for System Optimization

### Hybrid Execution Model

The system may dynamically leverage stateless and stateful execution to optimize mentor analysis efficiency, lesson structuring, performance tracking in session, and for storage optimization. In some embodiments, stateless analysis services that route audio and video data to dedicated endpoints for analysis may be prioritized. These may be separate endpoints than the front-end calls. For example, after a user plays a piece, the front-end may upload the audio to/analyze_audio and video frames to/analyze_video, then send results to the conversation service to generate feedback.

### Stateless for Speed & Scalability

Each PAM 106 analysis request may run independently and stateless. In other words, it may not retain past results unless explicitly stored in the curriculum management module CMM 104 or user profile for long-term tracking. Conversational responses, lesson progression, and knowledge base queries may execute statelessly, ensuring low-latency and parallel scalability.

### Stateful for Performance Analysis & Tracking

User skill assessment, performance history, and progress tracking (including the tools used in a session) may use stateful execution through storage in the KBR 105, allowing the core system 102 to compare multiple attempts and refine feedback dynamically.

### Performance Metrics Storage

The CMM 104 module may store structured data (e.g., accuracy, posture analysis) in an ephemeral session state, allowing objective performance tracking.

### Conversation History Storage

The CMM 104 may store the conversation history, or a condensed version of how the session went (summarized by the core system 102) for user progress tracking.

### Session Data Flow Optimization

The results of prior lessons may be stored in the User Context database in KBR 105 and retrieved across sessions, allowing for adaptive lesson progression and personalized feedback loops based on prior user progress. This scalable, cost-effective architecture may minimize server load while maintaining an engaging, structured user experience.

The figures depict preferred embodiments for purposes of illustration only. One skilled in the art will readily recognize from the following discussion that alternative embodiments of the structures and methods illustrated herein may be employed without departing from the principles described herein.

### Technical Solutions

Those skilled in the art will recognize that the disclosure provides a variety of technical solutions to technical problems in at least the fields of computing, artificial intelligence, virtual reality, augmented reality, modular computing and software architecture, data processing, etc. A non-exhaustive list of technical problems may include processing efficiency and speed, difficulty in incorporating personalized feedback, difficulty in providing a mentor-specific curriculum tailored to a specific user, and other problems evident to those skilled in the art. A list of non-limiting examples of such technical solutions follows. For each technical solution outlined below, more detail is included throughout the disclosure:

### Modular Architecture:

In some embodiments, the disclosure provides a modular architecture for separating different functions into distinct, coordinated modules. In some embodiments, this design may provide reliability and scalability across domains and may help distinguish the virtual mentoring system from traditional, monolithic AI tutors. In some embodiments, the architecture my be built on specialized modules, such as the Curriculum Management Module (CMM 104) for lesson logic, a Performance Analysis Module (PAM) 106 for user evaluation, and a Knowledge Base Retrieval (KBR) module 105 for mentor-specific data. In some embodiments, the Core System 102 may act as a “Mentor Model” to specify output as an “immersive interaction” (e.g., synced speech/avatar, media integration, etc.). In some embodiments, the disclosure may provide a session manager 103 as an orchestrator. In such embodiments, a central session manager may act as a “conductor,” coordinating the interactions between the independent modules to create a single, cohesive user experience. The disclosure may include structured context passing, in which the modules may be designed to pass structured data and context back to the core mentor model, which may allow for precise control over the virtual mentor's behavior within the lesson. Further, the modular architecture may include inter-module communication via structured formats (e.g., JSON time-codes) for enablement, and may provide for improving real-time interactivity via the separation of concerns described above.

### Deterministic Lesson Orchestration (e.g., via the CMM 104)

In some embodiments, the disclosure provides a unique method for controlling the mentor model flow through a lesson, ensuring it follows a structured curriculum like a real-life mentor. To do so, the disclosure describes, in some embodiments, machine-readable lesson scripts generated from mentor data, which may use a formal, deterministic script to define each step of the lesson. The disclosure also describes using tag-based control, which may include scripts using machine-interpretable tags to control the virtual mentor's actions, such as enabling specific tools, setting time limits, or permitting knowledge-base queries (e.g., by the KBR module 105). This may also include dynamic and conditional lesson flow. In some embodiments, such features may improve reliability and determinism of LLM-based models by providing guardrails to the LLM's output consistent with a pre-defined lesson plan, curriculum, and/or mentor style. For example, by restricting these LLM-based outputs to predefined formats or sequences aligned with lesson items, the system may reduce unpredictable or undesirable responses, such as hallucinations or skipping over lesson items, while enabling scalable deployment across diverse mentoring domains. In some embodiments, the system may dynamically branch the lesson to different paths based on the user's real-time performance (e.g., if a PAM score is below a certain threshold, branch to a remedial video). In some embodiments, the disclosure provides automated curriculum generation, such as by automatically generating structured lesson scripts based on mentor-specific materials and constraints.

### Mentor-Specific Authenticity (e.g., Via the KBR Module 105)

In some embodiments, the disclosure provides an end-to-end process for ensuring the virtual mentor gives more than generic advice, but authentically embodies the unique pedagogy, personality, and knowledge of a specific real-life mentor. In some embodiments, the disclosure provides a consent-aware/consent-tracking pipeline for data ingestion. This may include a system for collecting and processing a mentor's unique materials (videos, books, Q&A sessions) to form a knowledge base. The disclosure provides end-to-end mentor onboarding and knowledge synthesis. In some embodiments, this may provide a pre-session process for capturing a mentor's essence, identifying knowledge gaps, and creating the knowledge base used for authentic interactions with users. The disclosure also describes a fine-tuning process to replicate a mentor's teaching style and adaptive knowledge acquisition Q&A. This may include an interactive process that may conduct dynamic interviews with the real-life mentor to actively fill gaps in the virtual mentor model's knowledge that may not have been covered in other training materials. The disclosure may also provide automated authenticity testing, which may include an automated framework that runs benchmark scripts and dynamic role-play scenarios to verify the mentor model's alignment with the real mentor's style, knowledge, and ethical boundaries before deployment. This may include an automated process that may test the virtual mentor's responses against the real mentor's known behavior to ensure alignment and prevent deviation.

The disclosure may also provide curriculum-aware selective retrieval during user sessions. In some embodiments, the system may retrieve information based on the specific context of the lesson. Some technical features of this process may include, in some embodiments: KBR queries/directives and how the core system 102, CMM 104, and/or PAM 106 may dynamically invoke them, tag-indicated modes that may use tags in the lesson script to tell the system what kind of information to look for (e.g., a “biographical fact” vs. “performance feedback”), multi-index routing that may include querying different, specialized vector databases depending on the retrieval mode, and metric-bound triggers that may automatically retrieve specific feedback templates when a user's performance score crosses a predefined threshold.

### Real-Time Performance Analysis (e.g., by the PAM 106)

In some embodiments, the disclosure provides a method for analyzing a user's performance and providing substantially real-time, highly specific mentor-authentic feedback. For example, the methods may include a multimodal, time-coded analysis where the system may concurrently process both audio and video streams from the user in real time. The methods may include event detection with timestamps, where the system may automatically identify key performance events (both positive and negative) of a user performance and may attach precise timecodes to them. The method may include synchronized, annotated playback, where the system may replay the user's performance while displaying the virtual mentor, who may deliver commentary and visual annotations (e.g., highlighting incorrect hand posture) at the exact moment the corresponding time-coded event occurs. The method may include comparison to real life mentor benchmarks/standards based on the analysis results.

### Seamless Hybrid Media Integration

The disclosure provides a technical method for blending an interactive virtual avatar with pre-recorded/pre-rendered media of an associated real-life mentor, creating a single, cohesive experience for the user. The method may include curriculum-driven switching, whereby the lesson script may dictate the precise moments to switch between a live virtual avatar and a media segment. The method may include synchronized transitions, whereby the system may use technical methods like media preloading and avatar animation cues (e.g., a head turn) to make the transition between the two media types appear seamless and natural to the user.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method for providing structured virtual mentoring, comprising:
training, by a mentor knowledge base module, a mentor model using mentor-specific training data associated with a mentor;
generating, by the mentor knowledge base module, a mentor-specific knowledge database based on the mentor-specific training data;
providing, by a curriculum management module, a mentor-specific curriculum;
receiving, via a user interface of a user computing device, a performance input for a user performance;
analyzing, by a performance analysis module, the performance input to detect one or more performance features;
performing, by a knowledge base retrieval module, a query of the mentor-specific database to retrieve mentor-specific content, the query being initiated autonomously or based on at least one of performance features, or the mentor-specific curriculum;
determining, by the mentor model, a content type for a response based on at least one of the retrieved mentor-specific content, the mentor-specific curriculum, or the one or more performance features;
generating, by the mentor model, a response based on the retrieved mentor-specific content, the mentor-specific curriculum, and the one or more performance features; and
rendering, by the mentor model, the response in the determined content type via the user interface.

2. The method of claim 1, wherein the mentor-specific training data includes at least one of comprising annotated performance examples, instructional materials, or feedback templates associated with the mentor.

3. The method of claim 1 further comprising:
based on the one or more performance features, generating, by the performance analysis module, time-coded performance metrics; and
synchronizing, by the mentor model, the feedback response with the time-coded performance metrics.

4. The method of claim 1, wherein the query of a mentor-specific database is a vector query, and retrieving the mentor-specific content includes routing the vector query to a selected vector database based on a retrieval mode classification.

5. The method of claim 1, wherein rendering the response includes transitioning from a first content type to a second content type.

6. The method of claim 1, wherein the mentor-specific curriculum includes a syntax-defined lesson flow including one or more tagged steps and one or more conditional functions to maintain session progression.

7. The method of claim 1, wherein the mentor-specific curriculum includes a machine-interpretable lesson script comprising one or more state tags and one or more tool-permission tags that constrain the mentor model, and wherein generating the response includes validating, by a lesson controller, the response against the script.

8. The method of claim 7, wherein the lesson controller permits or denies function calls or the query of the mentor-specific database according to a curriculum-defined query directive encoded in the machine-interpretable lesson script.

9. The method of claim 1, wherein the query to retrieve the mentor-specific content is triggered based on the one or more performance features.

10. The method of claim 1 further comprising rendering, by an avatar director module, a virtual mentor avatar in coordination with the feedback response to deliver the feedback response via the user interface.

11. A computer-implemented method comprising:
generating, at a core system, a mentor-specific curriculum based on mentor-specific training data for a mentor;
receiving, at the core system from a user computing device, a performance input for a user performance;
analyzing, by the core system, the performance input, wherein the analysis includes:
implementing a performance analysis module to identify one or more performance features, and
implementing a curriculum management module to compare the one or more performance features to the mentor-specific curriculum;
determining, by the core system, a content type for a response based on at least one of the mentor-specific curriculum or the one or more performance features;
generating, by the core system, a response in the determined content type based on the comparison between the one or more performance features and the mentor-specific curriculum;
synchronizing, by the core system, the feedback response with time-codes associated with the one or more performance features; and
rendering, by the core system on the user computing device, the feedback response in the determined content type via the user interface.

12. The method of claim 11, wherein the performance analysis module identifies one or more key performance moments using one or more analysis models.

13. The method of claim 11, wherein the mentor-specific curriculum includes curriculum-based rulesets for comparing to the one or more performance features.

14. The method of claim 11, wherein comparing the one or more performance features to the mentor-specific curriculum includes querying a selected vector database.

15. The method of claim 14, wherein the query of the selective vector database includes a retrieval mode classification.

16. The method of claim 11 further comprising updating, by the curriculum management module, a user progress profile based on the performance features and feedback response.

17. The method of claim 16, wherein the curriculum management module is configured to adapt a lesson flow based on milestone attainment and performance thresholds.

18. The method of claim 11 further comprising introducing, based on the one or more performance metrics, media content of the mentor.

19. The method of claim 12 further comprising providing annotated playback of the user performance based on the one or more key performance features.

20. A non-transitory computer-readable storage medium containing instructions for a method for providing a virtual mentor, the method comprising:
training, by a computer, a mentor model based on input data to generate a trained mentor model, where the input data includes information related to a mentor;
receiving, by the computer, one or more video inputs from a user computer, the video inputs including a user performance;
analyzing, by the computer using the trained mentor model, the user performance to detect one or more performance features;
generating, by the computer using the trained mentor model, at least one feedback response based on the one or more performance features; and
generating, by the computer, a virtual mentor avatar configured to provide at least one feedback response to the user computer for display by the user computer.
